(19) United States
(12) Patent Application Publication
(10) Pub. No.: US 2001/0014868 A1
(43) Pub. Date: Aug. 16, 2001

(54) SYSTEM FOR THE AUTOMATIC DETERMINATION OF CUSTOMIZED PRICES AND PROMOTIONS

(76) Inventors: FREDERICK HERZ, WARRINGTON, PA (US); JASON EISNER, PHILADELPHIA, PA (US); LYLE UNGER, PHILADELPHIA, PA (US); WALTER PAUL LABYS, PHILADELPHIA, PA (US); BERNIE ROEMMELE, QUACKERTOWN, PA (US); JON HAYWARD, DOYLESTOWN, PA (US)

Correspondence Address: MELVIN A. HUNN, HILL & HUNN, LLP, 201 MAIN STREET, SUITE 1440, FORTH WORTH, TX, 76102, US

(21) Appl. No.: 09/120,611

(22) Filed: Jul. 22, 1998

Related U.S. Application Data
(63) Continuation-in-part of application No. 08/985,732, filed on Dec. 5, 1997.
Application No. 08/985,732 is a continuation-in-part of application No. 08/985,731, filed on Dec. 5, 1997, now Pat. No. 6,029,195.

(51) Int. Cl. G06F 17/60

(52) U.S. Cl. 705/14; 705/10; 705/26

(57) ABSTRACT

The system for the automatic determination of customized prices and promotions automatically constructs product offers tailored to individual shoppers, or types of shopper, in a way that attempts to maximize the vendor's profits. These offers are represented digitally. They are communicated either to the vendor, who may act on them as desired, or to an on-line computer shopping system that directly makes such offers to shoppers. Largely by tracking the behavior of shoppers, the system accumulates extensive profiles of the shoppers and the offers that they consider. The system can then select, present, price, and promote goods and services in ways that are tailored to an individual consumer. Likely shoppers can be identified, then enticed with the most effective visual and textual advertisements; deals can be offered to them, either on-line or off-line; detailed product information screens can be subtly rearranged from one type of shopper to the next. Furthermore, when a product can be tailored to a particular shopper, a general technique or expert system can offer each consumer an appropriately customized product.

### CROSS-REFERENCE TO RELATED APPLICATIONS

This patent application is a continuation-in-part of U.S. patent application Ser. No. 08/985,732, filed Dec. 5, 1997, and titled “System for Generation of Object Profiles for a System for Customized Electronic Identification of Desirable Objects” and U.S. Pat. application Ser. No. 08/985,731, filed Dec. 5, 1997, and titled “System for Generation of Object Profiles for a System for Customized Electronic Identification of Desirable Objects” which applications are both assigned to the same assignee as the present application.

### FIELD OF THE INVENTION

This invention relates to a system for the automatic determination of which products a shopper would be most likely to buy, and what prices and promotions (coupons, advertisements) a vendor should offer the shopper in order to maximize the vendor's profits. The system automatically constructs and updates profiles of a plurality of shoppers based on their demographics and their history of shopping behavior, which history includes both their purchases and their requests for, or reactions to, product information. A shoppers behavior in response to various possible product offers is then predicted by considering how those shoppers with the most similar profiles have behaved with respect to the most similar offers.

### Problem

It is a problem in the field of commercial sales to present consumers with products at prices that are most appropriate for the consumer. Any vendor with power to set prices faces the problem of setting them so as to maximize profits. The optimal price (the price that maximizes profits) is a function of consumer demand, that is, of the sales volume that the vendor will enjoy at each possible price. Depending on the consumers' demand curve, a given price reduction may or may not increase the vendor's sales volume enough to compensate for the associated reduction in profit margin. Different groups of consumers may have different demand curves, and hence different optimal prices. A vendor can increase profits by identifying many such groups of consumers and offering a distinct, profit-maximizing price to each. In the limit, the vendor might offer a different price to each individual. This scenario, however, presents a new problem: how can the vendor empirically determine the demand curves of small groups or individuals? This problem generalizes beyond price selection. A vendor does not merely set a price, but rather makes offers to consumers: each offer consists of a particular product, advertised in a particular way and at a particular price. Just as the vendor's choice of price affects demand and profit margin, so do the other properties of the offer—the vendor's choices of product and advertisement. The way in which they affect demand depends, again, on the particular consumer group. A vendor can therefore increase profits, in general, by making different offers to different consumer groups—that is, by offering different products, or the same products differently advertised or priced. A vendor who wishes to do so must determine each group's demand for various possible offers. Particularly in the context of on-line shopping, these problems are not hypothetical. In conventional retail channels, it is difficult to identify fine-grained consumer groups and target them individually with offers. Not so in the on-line world. On-line shopping allows detailed histories of shopping and purchasing behavior to be collected—down to the level of how long a shopper studied a product's photograph, technical specification, or ad copy. Shoppers who have similar histories may be expected to behave similarly as consumers, to exhibit similar patterns of demand. When the ability to instantly present special offers and discounts is supported by the ability to profile consumers in this way and anticipate their responses, new marketing opportunities arise. There is a long history of using many of these techniques in off-line applications such as market research. Retail sales have long been analyzed for different demographic or regional groups and using the results to decide which catalog to mail based on demographics. On-line shopping allows further customization, down to the level of the single individual based on “click streams” (the sequence of keys pressed on a computer) or purchase histories of that individual.

### Solution

The above problems are solved and a technical advance achieved in the field by the system for the automatic determination of customized prices and promotions. The system automatically constructs product offers tailored to individual shoppers, or types of shoppers, in a way that attempts to maximize the vendor's profits. These offers are typically represented to the shoppers in digital form. They are communicated either to the vendor, who may act on them as desired, or to an on-line computer shopping system that directly makes such offers to shoppers. The shoppers can be in the market for any type of product or service, including but not limited to: retail products, financial services, professional services, and the like.

Largely by tracking the behavior of shoppers, the system accumulates extensive profiles of the shoppers and the offers that they consider. The tracking can comprise a number of sources of data to thereby utilize multiple attribute clustering to provide a more powerful analysis capability. The system can then select, present, price, and promote goods and services in ways that are tailored to an individual consumer. Likely shoppers can be identified, then enticed with the most effective visual and textual advertisements; deals can be offered to them, either on-line or off-line, when these are likely to tip the balance; detailed product information screens can be subtly rearranged, lengthened, or shortened from one type of shopper to the next. Furthermore, when a product can be tailored to a particular shopper, a general technique or expert system can offer each consumer an appropriately customized product. Many related opportunities also exist. For example, just as on-line advertisements can be directed to particular shoppers, so can advertisements on cable TV. Just as price points can be determined for a particular shopper, so can payoff points for wagers. And just as promotional material can be personalized to highlight the promotions with the greatest chance of success, an “electronic mall” can be personalized to highlight the products that the consumer is most likely to buy. All these methods build on the profiling methods described in U.S. Pat. No. 5,758,257 titled “System for Generation of Object Profiles for a System for Customized Electronic Identification of Desirable Objects”. People who shop for the same things, and in the same way, tend to purchase similar products and respond to similar promotions. Furthermore, the less immediate costs and benefits of selling a given product to those people are similar. That is, not only are they be willing to pay about the same price, but sales to them inspire about the same degree of satisfaction and brand loyalty for future purchases, and carry about the same costs for shipping, service, and fraud. As explained in the U.S. Pat. No. 5,758,257, shoppers can be profiled in terms of both their demographic characteristics (age, income, family structure, ethnicity, and the like) and their past shopping behavior (products purchased, length of time since last purchase, allocation of browsing time, attention span, price sensitivity, interest in detailed features, impulse buys, use of coupons, and the like). Offers can be profiled as well. Possible attributes for offers include the newness and advertised duration of the offer, the type of product or service being offered, the product's brand name and features, the shoppers who tend to buy the product, other products frequently bought on the same shopping trip, the sales pitch, the price and terms of payment, any discounts provided, and the relative attributes of competing offers. The system of U.S. Pat. No. 5,758,257 describes several techniques that can be used for exploiting these profiles of shoppers (called “users” there) and offers (called “target objects” there):

a.) Grouping together shoppers, or offers, with similar profiles. A homogeneous group of shoppers formed in this way tends to exhibit a fairly homogeneous response toward a homogeneous group of offers. This is useful in drawing generalizations about future behaviors.

b.) Predicting the probability that a given shopper will accept a particular offer. This is useful for deciding which of several offers to make.

c.) Predicting the expected profit from making a particular offer, taking into account the expected value of the quantity (perhaps zero) that the shopper will buy, as well as any long-term costs and benefits, appropriately discounted. This is a more refined version of the previous point.

d.) Helping a shopper locate desirable offers, via searching, filtering, and browsing tools. For example, a shopper might want to find sales, discounts, or other attractive prices on CDS similar in price and musical style to the ones that the shopper has bought in the past.

e.) Doing market research. Shopper profiles could be used to suggest customized joint promotions. For example, a data analysis might show that ski vacations tend to be purchased around the same time as ski clothes. This motivates a joint promotion: buy the vacation, and get a discount on the ski cap. Such promotions could potentially be offered automatically.

Some technical issues are also discussed: notably, clustering of shoppers and offers, “rapid profiling” of consumers who are new to the system, and compression of profile databases (including conventional databases of credit-card purchases) through the use of clustering.

### BRIEF DESCRIPTION OF THE DRAWING

FIG. 1 illustrates in block diagram form the overall architecture of the present system for the automatic determination of customized prices and promotions;

FIG. 2 illustrates an example of a hierarchical cluster tree used in the present system for the automatic determination of customized prices and promotions;

FIG. 3 illustrates a chart of typical offers that are processed by the present system for the automatic determination of customized prices and promotions;

FIG. 4 illustrates in flow diagram form the operation of the present system for the automatic determination of customized prices and promotions to automatically determine a shopper's's interest through the use of similarity measurements;

FIGS. 5A and 5B illustrate in flow diagram form the operation of the present system for the automatic determination of customized prices and promotions in the search of data for offers;

FIG. 6 illustrates an example of a menu tree used in the present system for the automatic determination of customized prices and promotions; and

FIG. 7 illustrates an example of a menu tree used in the present system for the automatic determination of customized prices and promotions.

### DETAILED DESCRIPTION

### Definitions

Relevant definitions of terms for the purpose of this description include: (a.) the contractual terms of an offer that one party might make to another (such as the first party's obligation to provide a particular product or service, the second party's obligation to pay a particular price in return via a specified or unspecified payment system, and any other present or future obligations imposed upon either party as conditions of the offer, possibly including but not limited to eligibility restrictions, discounts, future rebates, warrantees, frequent flier miles, sweepstakes eligibility, and guarantees of confidentiality), together with the details of the presentation of that offer to the second party, including any surrounding or accompanying product information or advertising material conveyed by such means as text, sound, or graphical images, are collectively termed an “offer”, (b.) the party choosing whether to make an offer is termed a “vendor”, (c.) the party to which an offer is made, and who may choose to accept or reject the offer, is termed a “shopper”, (d.) a digital representation of an offer's attributes, which may also include attributes of the vendor, is termed an “offer profile”, (e.) a digital representation of a shopper's attributes is termed a “shopper profile”, (f.) a summary of the degree to which a particular shopper likes or dislikes various offer profiles, which summary constitutes part of that shopper's profile, is termed the “offer demand summary” of that shopper, (g.) a profile consisting of a collection of attributes, such that a particular shopper likes offers whose offer profiles are similar to this collection of attributes, is termed a “search profile”, (h.) a specific embodiment of the offer demand summary of a shopper as a set of search profiles is termed the “search profile set” of the shopper, (I.) a collection of offers with similar offer profiles is termed a “cluster”, j.) an aggregate profile formed by averaging the offer profiles of all offers in a cluster is termed a “cluster profile”, (k.) a real number determined by calculating the statistical variance of the offer profiles of all offers in a cluster, is termed a “cluster variance,” (l.) a real number determined by calculating the maximum distance between the offer profiles of any two offers in a given cluster, is termed a “cluster diameter”.

This system teaches a variety of related techniques relevant to collecting and using profiles of shoppers, promotions, and products to increase the efficiency and profitability of on-line shopping. The following sections describe the implementation of the basic on-line price point system in detail, including customized price points and promotions, custom coupons, and custom construction of products such as insurance or investment portfolios. The architecture of the shopping system is covered first, then detail is given on how profiles of offers and shoppers are created, compared and clustered. The final set of sections then describe applications of the method: automatically selecting offers to maximize vendor profit, use of custom coupons, joint promotions of multiple items and construction of custom offers, shopper's agents and buyers clubs, and the use of profiles for enhancing off-line sales.

### Architecture of the Shopping System

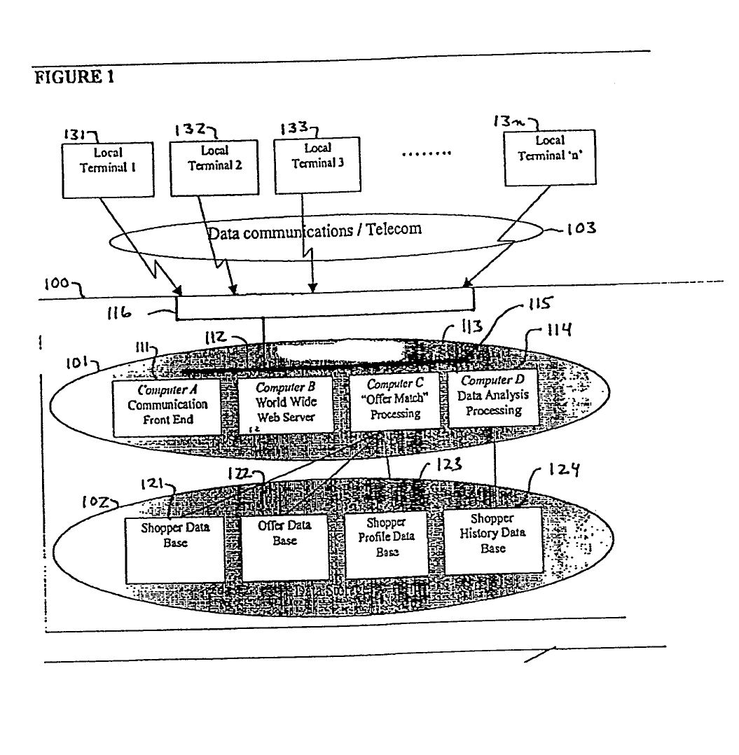

A typical architecture for the present system for the automatic determination of customized prices and promotions 100 is shown in FIG. 1. The system for the automatic determination of customized prices and promotions 100 communicates with shoppers by means of network connections via a land-line and/or wireless communications network 103 to the shoppers' computer terminals 131-13n. These terminals 131-13n can be any terminal device, from the shopper's personal computer device to in-store terminal devices, such as: point of sale terminals, information kiosks, small computers attached to shopping carts or coupon printers, which output coupons to the shoppers. The system for the automatic determination of customized prices and promotions 100 can interact with the point of sale devices to both populate the contents of the shopper database by using data retrieved from the point of sale (POS) devices to track user purchases, and to redeem offers that are presented to the shoppers.

In FIG. 1, the core of the system for the automatic determination of customized prices and promotions 100 comprises a data processing element 101 and a data storage element 102. The data processing element 101 (also termed “main computer”) comprises one or more processors 111-114 that perform the required functions in a cooperatively operative manner as described in additional detail below. The data storage element 102 comprises a plurality of databases, including, but not limited to: shopper database 121, offer database 122, shopper profile database 123, and shopper history database 124. In this typical architecture, each shopper is an individual who interacts with the system for the automatic determination of customized prices and promotions 100 through one of the terminals 131-13n that are capable of accepting input from the shopper and displaying text and/or graphics to the shopper. Generally, each terminal 131-13n is at a location that is remote to the system for the automatic determination of customized prices and promotions 100. The terminals 131-13n can be located in a retail establishment or can be located in the shopper's residence in the case of Internet access to the system for the automatic determination of customized prices and promotions 100. The terminals 131-13n are connected to a terminal communications interface 116 in the system for the automatic determination of customized prices and promotions 100 via a data communications link, such as a modem and a telephone connection established in well known fashion, or the communication medium can be ISDN, satellite, CATV, frame-relay, optical fiber or Ethernet. The link may also involve intermediate devices, such as other networked computers, that are able to forward data communications being sent between the local terminals 131-13n and the system for the automatic determination of customized prices and promotions 100.

The system for the automatic determination of customized prices and promotions 100 is typically constructed of a plurality of computers 111-114 that are networked together typically via a local area network 115. These computer systems 111-114 are sized and qualified for the different types of functions that must be performed to implement the system functionality. Thus, the communication front end computer 111 and the WorldWideWeb server 112 may be of a high reliability architecture that facilitates 100% up time, whereas the data analysis processing computer 114 may be optimized for fast numerical analysis and fast access to large amounts of shopping history data. While there are four computers 111-114 illustrated in FIG. 1, the number of computers required and the segmentation of function among these computers are matters of design choice and the particular configuration illustrated herein is for the purpose of illustrating the concepts of the system. While the architecture illustrated in FIG. 1 implies that the system elements are co-located, this is not the case, since the functionality implemented by the various elements presented in FIG. 1 can be implemented in a distributed system architecture.

The primary functions of the system for the automatic determination of customized prices and promotions 100 are (1) to identify offers that are appropriate for each shopper, (2) to help the shopper become informed about these available offers, and (3) to facilitate any or all of the necessary transactions, such as electronic ordering or payment, if the shopper decides to accept an offer. The present system for the automatic determination of customized prices and promotions 100 concerns functions (1) and (2). In order to carry these functions out, the main computer 101 has access to databases of information about possible offers (offer database 122), and about shoppers (shopper database 121) with whom it has dealt before. These databases 121-124 may be stored on hard disks or other storage devices that are accessible to the main computer 101, or in any other way that allows the main computer 101 to retrieve information from them, e.g., on one or more additional computers that are connected to the main computer via a data communications link. In the simplest case, the shopper database is a list of shopper profiles, including such information as demographic information and shopping history, indexed by shopper identifying name or number. Similarly, the offer database might be simply a list of offer profiles, including such information as the product, price and promotional material of each offer and, optionally, a list of shoppers who have considered or accepted the offer. In general, however, the databases 121-124 need not be simple lists. They may be represented in any format from which such offer profiles and shopper profiles could be reconstructed exactly or approximately.

The flow of information in the system for the automatic determination of customized prices and promotions 100 is as follows:

a.) A user inputs user identification data, using a frequent shopper card, an electronic identification, or a user name input from a terminal or kiosk.

b.) The system for the automatic determination of customized prices and promotions 100 then generates appropriate recommendations based on information in the various databases 121-124. The resulting recommendations are then used to generate offers. These may be coupons printed on an in-store kiosk or a computer at the shopper's home or downloaded to a PDA or smart card. They may be advertisements or promotions displayed through any of the above media, or they may be communicated directly to a point of sale device in a store or to the shopper's computer. When a shopper completes a sale, the price paid for each item can be adjusted according to the offers that are extended to this shopper and redeemed. The shopping can occur in any of a number of venues, such as: a retail establishment, public location, telephonically, on-line, and the like.

### On-Line Shopping Example

Our preferred application to demonstrate the use of the above architecture consists of the following steps, outlined here and discussed in more detail later.

1.) Profiles are collected which characterize shoppers and offers. Note that shoppers are characterized by demographic information, but more importantly by the offers that they have considered or accepted. Offers are characterized by their terms and by the shoppers that considered or accepted them.

TABLE A
Example Shopper and Offer profiles
(additional attributes presented below)

| Shoppers | Offers |
|---|---|
| age | item |
| sex | price |
| income | discount amount |
| web pages visited | discount form (coupon) |
| items purchased | list of shoppers who have accepted this offer |

The profile of a shopper is assembled in any or all of three ways:

a.) Some information is solicited when the shopper first registers with the shopping service. This information might include demographic information or a survey of purchase interests.

b.) Demographic and/or consumer information about the shopper or similar shoppers is obtained from other databases, e.g., from a consumer database purchased from a credit-card company, or a database that correlates the response to telemarketing campaigns with demographic variables.

c.) Records of the information requested and the products purchased by the shopper are incrementally collected during shopping, as is explained below.

Optionally, compress either or both databases by clustering. In the event that computer memory or speed is an issue, the shopper database can be compressed by clustering together similar shopper profiles, as discussed later. Each shopper profile is then replaced with its cluster's profile (which is similar to it, though not in general identical). This technique saves space because all the shoppers in the same cluster are given the same profile, which needs to be stored only once. Using cluster profiles rather than shopper profiles also helps to compensate for the fact that shopper profiles do not generally contain complete information about the shoppers they describe. The database of offer profiles may be compressed in the same way.

2. Determine Identity of Shopper—The shopper logs onto the system, if necessary first establishing a connection between the shopper's terminal and the main computer. At this point, the shopper's computer sends the main computer a shopper name or code that identifies the shopper. This shopper name or code may be manually input by the shopper at log-on time, or it may be stored on the shopper's terminal or on a smart card device that is read by the terminal. The main computer uses this identifying information to retrieve the shopper's profile, and perhaps related profiles, from the shopper database.

3. Determine Shopper's Goals—Optionally, the shopper may indicate a particular type of offer in which he or she is interested—for example, large-sized, mail-order dress shirts costing under $30. Any available interface for on-line navigation may be used here. For example, the shopper may browse through an on-line catalog, or may progressively narrow a search by using keywords (“dress shirts”), forms, and/or menus.

4. Select offers—The main computer selects offers from the offer database that are likely to result in profitable sales. Methods for doing this, which are described later in more detail, require the system to predict which offers the shopper would be likely to accept. The likelihood of acceptance can be calculated, in the simplest case, by counting what fraction of shoppers (or similar shoppers) who were presented with this offer (or similar offers) chose to accept. A key question is how to determine similarity. To this end, the system considers not only the shoppers present goals (as determined in step 3) and the offer profiles, but also the stored profile of this shopper. The shoppers profile includes a summary of offers that the shopper has accepted in the past, as well as demographic and psychographic data that aid in identifying similar shoppers. The system may amplify the shopper's profile with his or her present goals, as mentioned above, and with any offers that the shopper has recently considered or accepted. For example, if the shopper has just bought ski goggles, the system might select offers of other ski-related equipment that is frequently bought along with ski goggles. Once the system has determined a shoppers likelihood of accepting a given offer, it can calculate the expected profit from making that offer (namely, the profit if accepted times the probability of acceptance). However, expected profit is only one criterion that a vendor might use to select offers. Vendors often prefer not to maximize short-term profit but rather to build a long-term relationship with a shopper. This may involve selecting offers that have lower expected profit, but that are likely to improve the shopper's perception of the vendor, or allow the vendor to gather further information about the shopper's preferences which can be used to sell future items. Hence, other selection criteria may be used.

5. Present selected offers to shopper—By sending text and/or graphics to the shopper's terminal, perhaps interactively in response to further choices made by the shopper, the main computer describes the selected offers to the shopper. Offers that are directly relevant to the shopper's stated goals might be displayed more centrally than offers that the shopper may be interested in but has not explicitly asked for. The shopper may browse through the offers and accept one or more. In some shopping domains, the system may then be used to assist in consummating accepted offers, for example by transmitting accounting information, electronic payments, or informational goods between the vendor and the shopper. If a shopper elects not to accept an offer immediately, the system may, at the vendors option, provide the shopper with a “coupon” (or other credential) certifying that the shopper is entitled to the same offer until some future date. The coupon consists of a short document specifying the ID of the shopper, the terms of the offer, and the date of expiration. In general, techniques well-known in the art would be used to represent the coupon digitally, digitally sign it to prevent forgery or alteration, and electronically transmit it to the shoppers terminal, where it would be stored for future use. However, the coupon could instead be electronically transferred at the point of sale to a smart card held by the shopper, or printed as a paper coupon of which the merchant retains a paper or electronic record to guard against forgery or alteration. Coupons may be treated as non-transferable. That is, no matter what physical form the coupon takes, the vendor may require that anyone attempting to use such a coupon verify his or her identity, either by physical means, such as presenting a fingerprint or driver's license, or by electronic means, such as entering a password or providing other information. Such coupons have four purposes. First, if the shopper returns with the coupon, the vendor is spared the computation of re-selecting the most appropriate offer. Second, the coupon temporarily “locks in” the offer for the shopper against future changes in the vendor's pricing policy. Third, the coupon may serve to remind the shopper of the offer. Fourth, coupons of the same sort can be distributed en masse to a group of potential on-line and/or off-line shoppers, as part of an advertising campaign.

6. Update shopper's profile—As the shopper considers and selects products and offers in steps 3 and 5 above, the system monitors the shoppers interest in various offers. The main computer uses this information to update the shopper's profile in the shopper database, as described in step 1. In particular, the system updates the shopper's offer demand summary. The improved information helps determine the shopper's preferences for future shopping, as well as the preferences of similar shoppers. The shopper's interest in an offer may be determined in any of several ways. In active feedback, the shopper explicitly indicates his or her interest, for instance, on a scale of −2 (active distaste) through 0 (no special interest) to 10 (great interest). In our preferred mode of passive feedback, the system infers the shopper's interest from the shopper's behavior. For example, the system might monitor which offers the shopper chooses to view, or not to view, and how much time the shopper spends viewing them. A typical formula for assessing interest in an offer via passive feedback, in this domain, on a scale of 0 to 10, might be:

+1 if the offer matches the shopper's current interest but was not shown to the shopper,

+1 if the shopper spent more than 15 seconds viewing the offer,

+1 if the shopper explicitly chose to view the offer,

+1 if the shopper chose to view the offer more than once,

+1 if the offer was not the first offer listed but the shopper chose to view it first,

+5 if the shopper accepted the offer.

Other potential sources of passive feedback include an electronic measurement of the extent to which the shopper's pupils dilate while the shopper views the offer. It is possible to combine active and passive feedback. One option is to take a weighted average of the two ratings, where the weight may or may not vary from shopper to shopper, and where each such weight may optionally be continually adjusted by the system so as to improve the predictions made by the system, such as the predictions of shopper interest in offers that are computed as taught in the section “Determining Shoppers' Interest Through Similarity,” below, and in subsequent sections. Another option is to use passive feedback by default, but to allow the shopper to examine and actively modify the passive feedback score. For instance, an uninteresting offer may sometimes remain on the shopper's terminal for a long period while the shopper is engaged in unrelated business; the passive feedback score might be inappropriately high, and the shopper may wish to correct it before continuing. In one embodiment of this option, a visual indicator, such as a sliding bar or indicator needle on the shopper's screen, can be used to continuously display the passive feedback score estimated by the system for the offer being viewed, unless the shopper has manually adjusted the indicator by a mouse operation or other means in order to reflect a different score for this offer, after which the indicator displays the feedback score actively selected by the shopper, and this active feedback score is used by the system instead of the passive feedback score. In a variation, the shopper cannot see or adjust the indicator until just after the shopper has finished viewing the offer. Regardless how a shopper's feedback is computed, it is stored long-term as part of that shopper's offer demand summary. In a variation, each shopper's profile includes not one but two offer demand summaries. The first offer demand summary describes the offers that the shopper is likely to spend time reading, while the second offer demand summary describes the offers that the shopper is actually likely to buy. Offers may be selected in step 4 using a weighted combination of the two offer demand summaries.

### Variations on the Architecture

The basic architecture depicted in FIG. 1 may be varied in several ways without substantially affecting the on-line shopping example above.

A shopper's terminal might consist of an electronic advertising billboard or a point-of-sale kiosk. The shopper might actively log onto such a terminal by entering an identification code or inserting a credit card or smart card (perhaps a card issued by the store to the shopper, either permanently or for the duration of the shopper's visit). Alternatively, the terminal might be equipped with hardware and/or software that could actively recognize the shopper's face, retina, personal digital assistant (PDA), smart card, or automobile without any action on the shopper's part.

The shopper's profile might be accessible to the shopper's terminal without the intervention of the main computer. In a first variation, the shopper database is not accessible to the main computer of the shopping system; rather, each shopper's profile is stored by that shopper's terminal or by a smart card carried by the shopper. A second variation is identical to the first variation, except that each shopper's profile is also indirectly accessible to the main computer, in that the shoppers terminal will send the main computer all or part of the shoppers profile when necessary, and/or modify the shoppers profile upon receipt of an appropriate request from the main computer. In a third variation, the shopper database is accessible to both the main computer and each shoppers terminal, for example over separate data communications links. In any of these variations, the shopper's profile is accessible to the shoppers terminal or smart card, so the shopper's terminal or smart card rather than the main computer may perform the task of updating the shopper's profile based on feedback, as described above in the step “Update shopper's profile.” Similarly, the shopper's terminal or smart card rather than the main computer may also perform part or all of the task of selecting offers that are relevant to the shopper, in that the main computer may select a set of many such offers and transmit them to the shoppers terminal, whereupon the shopper's terminal or smart card selects a subset of these offers that are particularly relevant to the shopper, based on the shopper's profile.

Notice that the first variation provides the shopper with extra privacy, in that the shopper's profile is not revealed to the main computer of the shopping system. In the second variation, the shopper might have the ability to set a privacy policy, i.e., to restrict the terminal or smart card so that it uploads only certain profile data to certain systems. In all three variations, some of the computational work is performed by the shopper's terminal or smart card rather than by the main computer of the shopping system, and this may improve the speed or the cost of the system.

Any of the transactions between the main computer and a shopper or shopper's terminal might instead be handled through other means of communication, such as conventional mail, electronic mail, telephone, and conventional payment systems. For example, vendors could select offers for a shopper using the profile-based method introduced above, but present the offers not through an interactive application but rather by a customized catalog or coupon sheet sent by surface mail. (Passive feedback is more difficult to collect in this case.) Whether the shopper receives offers by mail or electronically, he or she might use the telephone to accept offers or make further inquiries. And whether the shopper accepts electronically or otherwise, he or she might pay by either electronic or non-electronic means. A given instantiation of the shopping system might mix on-line and off-line interactions freely, potentially dealing with the same shopper by a variety of different means. Moreover, the shopper database and offer database might be updated by other processes not described in detail above: for example, the shopper database might also include details of the shoppers' transactions with other vendors, for example in the form of credit-card histories, which would be updated regularly.

In the system described in U.S. Pat. No. 5,758,257, users may also conceal their identities through use of pseudonymous or multiple pseudonyms using a pseudonymous proxy server or a trusted third party may conduct the actual transactions and thus are responsible for maintaining the user profiles. This system concept can be directly incorporated into the present system architecture in the case of remote access of the user terminal via a communication facility. In any event, in such conditions in which the user is granted control over higher user profile data, it is also beneficial to seek to facilitate using automated techniques, the controlled disclosure of such data to desired vendors privacy of all or certain portions of the user profile in order to encourage the user to share that data with the vendor. As such, the user may initiate privacy policies whereby the user explicitly states which attributes of vendors (or which types of vendors) the user is willing to disclose which attributes within his/her profile to (e.g., directly or pseudonymously). Or conversely which vendor types the user is definitely not willing to share his/her profile with (or which portions thereof). In this way, the user could of course specify an example vendor which would be generalized to all similar vendors as determined by the similar methods presently described below. The user interface for such a system could utilize rapid profiling in order to identify the most relevant policy queries, particularly those which are most relevant to users sharing other similar components of their particular privacy policy. Appropriate disclose of user profile data in accordance with these policies may then be performed automatically.

### Profiles and Attributes

This section describes the data format of profiles, and gives a general procedure for automatically measuring the similarity between two shopper profiles or two offer profiles. Knowing which profiles are similar allows the shopping system to generalize when predicting shoppers' preferences. Moreover, the ability to group shoppers or offers by similarity is useful when forming buyers' clubs or determining an appropriate layout for an “electronic mall.” The generality of this problem motivates a general approach. It is assumed that many shoppers and offers are known to the shopping system, and that the system stores (or has the ability to reconstruct) several pieces of information about each shopper and each offer. These pieces of information are termed “attributes”: collectively, they are said to form a profile of the shopper or the offer. Profiles should be configured to specify attributes that are appropriate for the particular shopping domain in which the invention is used.

### Offer Profiles

For example, suppose that the on-line shopping system is designed to sell clothing. Each offer invites the shopper to buy some article of clothing on some terms. Offer profiles might then be set up to include attributes such as, but not limited to, the following:

a.) title of garment,

b.) brand name used by garment's manufacturer,

c.) type of garment (e.g., dress shirt),

d.) impartial textual description of garment,

e.) advertising copy for garment (shown to shopper as part of offer),

f.) string of keywords specifying age, race and gender of model(s) in advertising photo,

g.) reading level of advertising copy,

h.) number of colors in garment's pattern,

I.) formality rating (1=very casual, 5=very formal)

j.) size of garment (1 =X-Small, 5=X-Large),

k.) percentile ranking of wholesale cost among garments of the type specified in (c),

l.) nominal price asked (in dollars),

m.) percentage discount offered (perhaps zero),

n.) discounted price asked,

o.) list of shoppers who have previously shown interest in this offer,

p.) list of colors used in garment's pattern,

q.) list of materials used to make garment,

r.) list of endorsements from consumer agencies.

Each offer may in general have a different set of values for these attributes, but sometimes two offers will differ in only a few attributes, such as their price or advertising copy. The above example conveniently illustrates three common kinds of attributes. Attributes (g)-(n) are numeric attributes, of the sort that might be found in a database record. It is evident that they can be used to help identify offers of interest to a known shopper. For example, the shopper might previously have purchased many garments that are fairly casual, that are in about the fortieth percentile of cost for their garment type, and that are presented as discounted items. This generalization is useful: new offers having numerically similar values for these attributes (that is, formality rating near 2, cost percentile near 40, discount percentage near (say) 20) are judged similar to the offers the shopper has accepted in the past, and therefore more likely to be accepted. Attributes (a)-(f) are textual attributes. They too are important for helping to identify promising offers. For example, perhaps the shopper has shown a past interest in offers for products bearing the “Hippity-Hop” brand label, or offers whose advertising copy (attribute (e)) contains such words as “rugged,” “Thinsulate,” and “tailored.” This generalization is again useful in identifying offers of interest. Finally, attributes (o)-(r) are associative attributes. Each records associations between an offer and ancillary objects of a different sort, such as shoppers, colors, materials, or endorsements. For example, if the shopper has often accepted offers that shopper C17 and shopper C190 have also accepted, then the shopper will be judged more likely to accept other such offers, which have similar values for attribute (o). In a more sophisticated variation, an associative attribute consists of not only a list of ancillary objects but also a numeric association score for each ancillary object. Thus, attribute (o) could indicate an interest level for each shopper listed as assessed through passive feedback (see above), attribute (p) could indicate how prominent each color in the garment was, attribute (q) could list the percentages of cotton, polyester, silk, cashmere, wool, etc., used in the fabrication of the garment, and attribute (r) could list the strength of each endorsement received. While the true asking price in the above example is specified by attribute (n), attributes (I)-(m) concern how that price is presented to the shopper. How a price is presented may be as important as other characteristics of the offer, such as the price, features, brand name, and promotional material. Several presentations besides a flat “price tag” are available (and each offer profile should include attributes describing the presentation). For example, a product could be presented as a $25 item, as a $35 item with a $10 discount, as a $27 item with a bonus travel clock thrown in, as a $30 item with a ⅙chance of getting the item for free, as a $30 item where the shopper has a ⅕chance of being granted a 2-for-1 deal, as a $50 item that is part of a store-wide “50%-off” discount, or even as a $30 item whose price will be lowered to $25 and then to $20 if the consumer hesitates long enough. While all these price presentations are effectively presenting the price “$25,” in that they will gross about $25 per unit sold, some of them will elicit more sales than others from a given shopper or group of shoppers. Other offers with higher or lower effective prices might also be considered.

As another domain example, if the offers are pay-per-view movies, offer profiles might be set up to include attributes such as, but not limited to, the following:

a.) title of movie (textual),

b.) name of director (textual),

c.) Motion Picture Association of America (MPM) child appropriateness rating (O=G, 1=PG, . . . ) (numeric),

d.) date of release (numeric),

e.) number of stars granted by a particular critic (numeric),

f.) number of stars granted by a second critic (numeric),

g.) number of stars granted by a third critic (numeric),

h.) full text of review by the second critic (textual),

I.) list of shoppers who have previously rented this movie (associative),

j.) list of actors (associative),

k.) duration of movie in minutes (numeric),

I.) price in dollars (numeric). As another domain example, if the offers are pay-per-view electronic documents, profiles might include attributes such as, but not limited to, the following:

a.) full text of document (textual),

b.) title (textual),

c.) author (textual),

d.) language in which document is written (textual),

e.) date of creation (numeric),

f.) date of last update (numeric),

g.) reading level (numeric),

h.) quality of document as rated by a third-party editorial agency (numeric),

I.) list of other readers who have retrieved this document (associative),

j.) length in words (numeric), As another domain example, if the offers are offers to buy or sell stock in publicly traded corporations, profiles might include attributes such as, but not limited to, the following:

a.) type of business (textual),

b.) corporate mission statement (textual),

c.) number of employees during each of the last 10 years (ten separate numeric attributes),

d.) age of company (numeric),

e.) percentage growth in number of employees during each of the last 10 years (numeric),

f.) percentage appreciation of stock value during each of the last 40 quarters (numeric),

g.) list of major shareholders (associative),

h.) percentage of shares held by mutual funds (numeric),

I.) percentage of shares held by shareholders owning 100 or fewer shares (numeric),

j.) composite text of recent articles about the corporation in the financial press (textual),

k.) current share price (numeric),

I.) current price-earnings ratio (numeric),

m.) beta value—a measure of volatility (numeric),

n.) dividend payment issued in each of the last 40 quarters, as a percentage of current share price (numeric).

Some attributes in the profile of a purchasable ad or promotion could include activity as a function of time. The number of purchases made or information requests (e.g. web pages retrieved) over a given time interval by all shoppers or by shoppers with certain attributes may be useful in predicting the best long term ad campaign for a given product for each shopper. It may also allow more accurate prediction of shopper interest for the.

### Shopper Profiles

A wealth of information about each shopper may be available. Shopper profiles might be set up to store many attributes such as, but not limited to, the following:

a.) number of times the shopper has used the on-line shopping system

1 0 (numeric),

b.) average duration per use of the system (numeric),

c.) total number of previous purchases (numeric),

d.) average number of purchases per use of the system (numeric),

e.) mean time spent considering an offer that is eventually accepted (numeric),

f.) standard deviation of time spent considering an offer that is eventually accepted (numeric),

(g-I) same as (a-f) but for the past month only,

(m-r) same as (a-f) but for the “garment department” of the system only,

s.) age of shopper (numeric),

t.) gender of shopper (textual),

u.) likely ethnicity of shopper as guessed from shopper's surname (textual),

v.) first two digits of zip code (textual),

w.) first three digits of zip code (textual),

x.) entire five digit zip code (textual),

y.) estimated average household income in shopper's zip code (numeric),

z.) distance of shopper's residence from advertiser's nearest physical storefront (numeric),

aa.) number of children shopper has (numeric),

bb.) list of products about which shopper has previously requested information (associative),

cc.) list of offers accepted to date by shopper (associative),

dd.) list of offers for which the shopper is known to hold discount coupons previously issued (associative),

ee.) written response by shopper to Rorschach inkblot test (textual),

ff.) multiple choice responses by this shopper to 20 self image questions (20 textual attributes),

gg.) list of on-line newspapers and magazines subscribed to by shopper (associative),

hh.) list of other vendors from whom the shopper has accepted offers, as determined from the shopper's credit-card history (associative).

When predicting the interest of a shopper U in an offer X, it is in general impossible to find shoppers identical to U who have previously considered offers identical to X. However, predictions of shopper U's likely interest can be made by considering the past interest of shoppers whose profiles are similar to U's in offers whose profiles are similar to X's, provided that such past interest has been determined by passive or active feedback. A number of techniques have been developed by statisticians to handle the sparse data problem. The more sophisticated ones use detailed information when it is available (e.g., if we have a set of shoppers who have similar patterns of browsing and shopping), and fall back to more general information (e.g. gender and age and income category) when less information is available. Some techniques of this sort will be taught herein.

### Decomposing Complex Attributes

Although textual and associative attributes are large and complex pieces of data, for some purposes they can be decomposed into smaller, simpler numeric attributes. This means that any set of attributes can be replaced by a (usually larger) set of numeric attributes, and hence that any profile can be represented as a vector of numbers denoting the values of these numeric attributes. In particular, a textual attribute, such as the full text of a product description, can be replaced by a collection of numeric attributes that represent scores to denote the presence and significance of the words “aardvark,” “aback,” “abacus,” and so on through “zymurgy” in that text. The score of a word in a text may be defined in numerous ways. The simplest definition is that the score is the rate of the word in the text, which is computed by computing the number of times the word occurs in the text, an d dividing this number by the total number of words in the text. This sort of score is often called the “term frequency” (TF) of the word. The definition of term frequency may optionally be modified to weight different portions of the text unequally: for example, any occurrence of a word in the text's title might be counted as a 3 fold or more generally k fold occurrence (as if the title had been repeated k times within the text), in order to reflect a heuristic assumption that the words in the title are particularly important indicators of the text's content or topic.

However, for lengthy textual attributes, such as the text of an entire document, the score of a word is defined to be not merely its term frequency, but its term frequency multiplied by another factor, “term weight.” The term weight is typically taken to be the negated logarithm of the word's “global frequency,” as measured with respect to the textual attribute in question. The global frequency of a word, which effectively measures the word's uninformativeness, is a fraction between 0 and 1, defined to be the fraction of all offers for which the textual attribute in question contains this word. This adjusted score is often known in the art as TF/IDF (“term frequency times inverse document frequency”). When the term weight of a word takes its global frequency into account in this way, the common, uninformative words have scores comparatively close to zero, no matter how often or rarely they appear in the text. Thus, their rate has little influence on the textual attribute. As will be discussed below, term weights may be adjusted based on feedback from shoppers. Alternative methods of calculating word scores include latent semantic indexing or probabilistic models.

Instead of breaking the text into its component words, one could alternatively break the text into overlapping word bigrams (sequences of 2 adjacent words), or more generally, word n grams. These word n grams may be scored in the same way as individual words. Another possibility is to use character n grams. For example, this sentence contains a sequence of overlapping character 5 grams which starts “for e”, “or ex”, “r exa”, “exam”, “examp”, etc. The sentence may be characterized, imprecisely but usefully, by the score of each possible character 5 gram (“aaaaa”, “aaaab”, . . . “zzzzz”) in the sentence. Conceptually speaking, in the character 5 gram case, the textual attribute would be decomposed into at least 26⁵ =11,881,376 numeric attributes. Of course, for a given offer, most of these numeric attributes have values of 0, since most 5 grams do not appear in the offer attributes. These zero values need not be stored anywhere. For purposes of digital storage, the value of a textual attribute could be characterized by storing the set of character 5 grams that actually do appear in the text, together with the nonzero score of each one. Any 5 gram that is not included in the set can be assumed to have a score of zero. The decomposition of textual attributes is not limited to attributes whose values are expected to be long texts. A simple, one term textual attribute can be replaced by a collection of numeric attributes in exactly the same way. Consider again the case where the offers are garments. The “brand name” attribute, which is textual, can be replaced by numeric attributes giving the scores for “Hippity-Hop,” “Laura-Ashley,” “Eddie-Bauer,” and so forth, in that attribute. For these one term textual attributes, the score of a word is usually defined to be its rate in the text, without any consideration of global frequency. Note that under these conditions, one of the scores is 1, while the other scores are 0 and need not be stored. For example, if the brand is in fact Hippity-Hop, then it is the term “Hippity-Hop” whose score is 1, since “Hippity-Hop” constitutes 100% of the terms in the textual value of the “brand name” attribute. It might seem that nothing has been gained over simply regarding the textual attribute as having the string value “Hippity-Hop.” However, the trick of decomposing every non numeric attribute into a collection of numeric attributes proves useful for the clustering and decision tree methods described later, which require the attribute values of different offers or different shoppers to be averaged and/or ordinally ranked. Only numeric attributes can be averaged or ranked in this way.

Just as a textual attribute may be decomposed into a number of component terms (letter or word n grams), an associative attribute may be decomposed into a number of component associations. For instance, in a domain where the offers are garments, a typical associative attribute used in profiling a garment would be a list of shoppers who have purchased that garment. This list can be replaced by a collection of numeric attributes, which give the “association scores” between the garment and each of the shoppers known to the system. In a subtler refinement, this association score could be defined to be the degree of interest, on a scale from 0 to 1, that shopper #165 exhibited in the movie, as determined by active or passive feedback (as described above). In this refinement, shopper #165's global frequency would be defined as his or her mean degree of interest over all garments. For example, the 165th such numeric attribute would be the association score between the garment and shopper #165, where the association score is defined to be 1 if shopper #165 has purchased the garment, and 0 otherwise. Just as with the term scores used in decomposing lengthy textual attributes, each association score may optionally be adjusted by a multiplicative factor, “association weight”: for example, the association score between a movie and shopper #165 might be multiplied by the negated logarithm of the “global frequency” of shopper #165, i.e., the fraction of all available garments that shopper #165 has purchased. Just as with the term scores used in decomposing textual attributes, most association scores found when decomposing a particular value of an associative attribute are zero, and a similar economy of storage may be gained in exactly the same manner by storing a list of only those ancillary objects with which the associative attribute records a nonzero association score, together with their respective association scores.

### Novelty Control for Collaborative Filtering

When making recommendations using collaborative filtering or any method which uses clustering, nearest neighbors, or agreement matrices, it is important to control the degree of novelty of recommendations. The most obvious recommendation methods produce recommendations that are obvious to the user/shopper: the most popular movie or CD will be recommended, since this is statistically what most people have purchased. Novelty control can be done by appropriately adjusting the associating weights. Recommending highly popular items may or may not be desirable; users often want a recommendation of something they would not think of themselves. This problem is particularly acute if the system does not have a complete record of prior purchases by the user—as it almost never does: how can it know all the books or CDS that one has bought. In this case, the most popular items should not be recommended or should be recommended less strongly since the user is more likely to already have them. We propose the following method for controlling the novelty of recommendations. If a customer I has purchased a vector of goods

Cᵢ={Cᵢ₁, Cᵢ₂, . . . Cᵢₘ}

where cᵢⱼ represents the number of goods of type j purchased by customer I, then the customer's profile is re-weighted to become:

Cᵢ={W₁Cᵢ₁, W₂Cᵢ₂, WₘCᵢₘ}

where the weights w are selected to reduce the importance of more frequently purchased items. This may be extended to the case where the vector cᵢ is any kind of profile of customer I, in which case some or all of the components of Cᵢ may be reweighted in this way. For example, cᵢⱼ might represent the rating given by customer I to goods of type j, rather than the number of such goods actually purchased. A simple and effective way to choose the weight wⱼ, for each j, is to set it to 1/sqrt(bⱼ) or to log(N/bⱼ), where bⱼ is the number of customers who have purchased or rated goods of type j and therefore can be expected to have prior knowledge of such goods, and where N is the total number of customers. This is analogous to weighting using inverse document frequency (IDF) in information retrieval. We prefer a more tunable weighting,

$${w}_{j} = 1.01 - exp ( alpha {b}_{j} + beta ) / ( 1 + exp ( alpha {b}_{j} + beta ) )$$

$$1.01 - \frac{exp ( α {b}_{j} + β )}{1 + exp ( α {b}_{j} + β )}$$

Different values of alpha and beta give different degrees of suppression of the more popular items. The resulting modified user profile is then used to calculate similarities between shoppers exactly as before. The overall consequence is that somewhat less popular (and hence more interesting) items are not overshadowed when preferences and recommendations are determined.

### Similarity Measurement Subsystem

What does it mean for two offers or two shoppers to be similar? More precisely, how should one measure the degree of similarity, when applying the methods taught herein? Many approaches are possible and any reasonable metric that can be computed over the relevant set of profiles can be used, where two offers or two shoppers are considered to be similar if the distance between their profiles is small according to this metric. Thus, the following preferred embodiment of a profile similarity measurement subsystem has many variations. First, define the distance between two values of a given attribute according to whether the attribute is a numeric, associative, or textual attribute. If the attribute is numeric, then the distance between two values of the attribute is the absolute value of the difference between the two values. (Other definitions are also possible: for example, the distance between prices p1 and p2 might be defined by:

$$\frac{\vert {p}_{1} - {p}_{2} \vert}{max ( {p}_{1} , {p}_{2} ) + 1}$$

to recognize that when it comes to shopper interest, $5000 and $5020 are very similar, whereas $3 and $23 are not.) If the attribute is associative, then its value V may be decomposed as described above into a collection of real numbers, representing the association scores between the shopper or offer in question (i.e., a shopper or offer whose profile has value V for this attribute) and various ancillary objects. V may therefore be regarded as a vector with components V₁, V₂, V₃, etc., representing the association scores between the shopper or offer and ancillary objects 1, 2, 3, etc., respectively. The distance between two vector values V and U of an associative attribute is then computed using the angle distance measure:

$$arccos ( {\sqrt{( {VV}^{′} ) ( {UU}^{′} )}}^{VU} )$$

(Note that the three inner products in this expression have the form XY^{t}=X₁ Y₁ +Y₂ Y₂ +X₃ Y₃ +. . . , and that for efficient computation, terms of the form Xᵢ Yᵢ may be omitted from this sum if either of the scores Xᵢ and Yᵢ is zero.) Finally, if the attribute is textual, then its value V may be decomposed as described above into a collection of real numbers, representing the scores of various word n grams or character n grams in the text. Then the value V may again be regarded as a vector, and the distance between two values is again defined via the angle distance measure. Other measures of the distance between two vector-valued (textual or associative) attributes, such as the dice measure, may be used instead. It happens that the obvious alternative distance measure, Euclidean distance, does not work well: even texts with similar content tend not to overlap substantially in the content words they use, so that texts encountered in practice are all substantially orthogonal to each other, assuming that TF/IDF scores are used to reduce the influence of non content words. The scores of two words in a textual attribute vector may be correlated; for example, “credit” and “installments” tend to appear in the same documents. Thus it may be advisable to alter the text somewhat before computing the scores of terms in the text, by using a synonym dictionary that groups together similar words. The effect of this optional pre alteration is that two texts using related words are measured to be as similar as if they had actually used the same words. One technique is to augment the set of words actually found in the textual attribute with a set of synonyms or other words which tend to co occur with the words in the textual attribute, so that “credit” could be added to every text that mentions “installments.” Alternatively, words found in the textual attribute may be wholly replaced by synonyms, so that “installments” might be replaced by “credit” wherever it appears. In either case, the result is that textual attribute values mentioning credit are judged more similar those mentioning installment plans. The synonym dictionary may be sensitive to the topic of the text; for example, it may recognize that “screwdriver” is likely to have a different synonym in a text that mentions alcohol than in a text that mentions tools. A related technique is to replace each word by its morphological stem, so that “staple”, “stapler”, and “staples” are all replaced by “staple.” Common function words (“a”, “and”, “the” . . . ) can influence the calculated similarity of texts without regard to their topics, and so are typically removed from the text before the scores of terms in the text are computed. A more general approach to recognizing synonyms is to use a revised measure of the distance between textual attribute vectors V and U, namely arccos(AV(AU)^{t}/sqrt (AV(AV)^{t} AU(AU)^{t}), where the matrix A is the dimensionality reducing linear transformation (or an approximation thereto) determined by collecting the vector values of the textual attribute, for all profiles known to the system, and applying singular value decomposition to the resulting collection. The same approach can be applied to the vector values of associative attributes. The above definitions allow us to determine how close together two profiles are with respect to a single attribute, whether numeric, associative, or textual. The distance between two offers X and Y with respect to their entire multi-attribute profiles Pₓ and P_{y} is then denoted d(X,Y) or d( Pₓ, P_{y}) and defined as:

$${\sum }_{k} {( {d}_{k} ( {P}_{Xk} , {P}_{Yk} ) {w}_{k} )}^{s} {)}^{1 / s}$$

where s is a fixed positive real number, typically 2, P_{Xk} and P_{Yk} denote the kth attributes of P_{X} and P_{Y} respectively, dk(*,*) is the single-attribute distance function that defines the distance between two values of the kth attribute in the manner disclosed above, and each wk is a non-negative real number, termed an “attribute weight” and specifically termed the weight of attribute k, that indicates the relative importance of attribute k in determining the distance between two profiles. Offer X is said to be similar to offer Y, and profile Pₓ similar to profile P_{y}, to the extent that d(X,Y) is close to zero. As an example, if the weight of the “list of colors” associative attribute is comparatively very small, then color is not a strong consideration in determining similarity: a shopper who likes a brown-and-white massage cushion is predicted to show about equal interest in the same cushion manufactured in blue, and vice versa. On the other hand, if the weight of the “color” attribute is comparatively very high, then shoppers are predicted to show interest primarily in products whose colors they have liked in the past: a brown-and-white massage cushion and a blue massage cushion are not at all the same kind of offer, however similar in other attributes, and a good experience with one does not by itself inspire much interest in the other.

Offers (or shoppers) may be of various sorts, and it is sometimes advantageous to use a single system that is able to compare profiles of distinct sorts. For example, in a system where some offers are books while other offers are videocassettes, it is desirable to judge a novel and a movie similar if their profiles show that similar shoppers like them (an associative attribute). However, it is important to note that certain attributes specified in the movie's offer profile are undefined (or specified as “Not Applicable”) in the novel's offer profile, and vice versa: a novel has no “cast list” associative attribute and a movie has no “reading level” numeric attribute. In general, a system in which offers fall into distinct sorts may sometimes have to measure the similarity of two offers for which somewhat different sets of attributes are defined. This requires an extension to the distance metric d(*,*) defined above. In certain applications, it is sufficient when carrying out such a comparison simply to disregard attributes that are not defined for both offers: this allows a cluster of novels to be matched with the most similar cluster of movies, for example, by considering only those attributes that novels and movies have in common. However, while this method allows comparisons between (say) novels and movies, it does not define a proper metric over the combined space of novels and movies and therefore does not allow clustering to be applied to the set of all offers. When necessary for clustering or other purposes, a metric that allows comparison of any two offers (whether of the same or different sorts) can be defined as follows. If a is an attribute, then let Max(a) be an upper bound on the distance between two values of attribute a; notice that if attribute a is an associative or textual attribute, this distance is an angle determined by arccos, so that Max(a) may be chosen to be 180 degrees, while if attribute a is a numeric attribute, a sufficiently large number must be selected by the system designers depending on the range of a and how distances among values of a are defined. The distance between two values of attribute a is given as before in the case where both values are defined; the distance between two undefined values is taken to be zero; finally, the distance between a defined value and an undefined value is always taken to be Max(a)/2. This allows us to determine how close together two offers are with respect to an attribute a, even if attribute a does not have a defined value for both offers. That is, it allows us to define the single-attribute distance functions dk(*,*) even in this case. The distance d(*,*) between two offers with respect to their entire multi attribute profiles is then given in terms of these individual attribute distances exactly as before. It is assumed that one attribute in such a system specifies the sort of offer (“movie”, “novel”, etc.), and that this attribute may be highly weighted if offers of different sorts are considered to be very different despite any attributes they may have in common.

### Rapid Profiling

Sometimes, a shopper's profile is insufficient to determine which other shoppers are similar to him or her. This is particularly true for a shopper who has not spent much time using the on-line shopping system, because, for example, the associative attribute that lists offers in which the shopper has previously shown interest will consist of only a short list of offers having non-zero association scores.

In the same way, complete profiles of offers are not always available, or easy to construct automatically. When offers are wallpaper patterns, for example, an attribute such as “genre” (a single textual term such as “Art Deco,”“Children's,” “Rustic,” etc.) may be a matter of judgment and opinion, difficult to determine except by consulting a human. More significantly, if each wallpaper pattern has an associative attribute that records the interest shown in that pattern (active and/or passive feedback) by each of various shoppers (consumers), then all the association scores of any newly introduced pattern are initially zero, so that it is initially unclear what other patterns are similar to the new pattern with respect to the shoppers who like them. Indeed, if this associative attribute is highly weighted, the initial lack of feedback may be difficult to remedy, due to a vicious circle in which shoppers of moderate to high interest are needed to provide feedback but feedback is needed to identify shoppers of moderate to high interest.

Fortunately, however, it is often possible in principle to determine certain attributes of a new shopper or offer by extraordinary methods, including but not limited to methods that consult a human. For example, the system can in principle determine the genre of a wallpaper pattern by consulting one or more randomly chosen individuals from a set of known human experts (who may or may not be shoppers), while to determine the numeric association score between a new wallpaper pattern and a particular shopper, it can in principle show that pattern to that shopper and obtain active and/or passive feedback. Since such requests inconvenience people, however, it is important not to determine all difficult attributes this way, but only the ones that are most important for purposes of classifying the document. “Rapid profiling” is a method for selecting those numeric attributes that are most important to determine for a particular type of profile. (Recall that all attributes can be decomposed into numeric attributes, such as association scores or term scores.) First, a set of existing shoppers or offers that already have complete or largely complete profiles are clustered using a k means algorithm. Next, each of the resulting clusters is assigned a unique identifying number, and each clustered profile is labeled with the identifying number of its cluster. Standard methods such as CART, ID3 and C4S then allow construction of a single decision tree that can predict any profile's cluster number, with substantial accuracy, by considering the attributes of the offer, one at a time. Only attributes that can if necessary be determined for any new offer are used in the construction of this decision tree. To profile a new offer, the decision tree is traversed downward from its root as far as is desired. The root of the decision tree considers some attribute of the offer. If the value of this attribute is not yet known, it is determined by a method appropriate to that attribute; for example, if the attribute is the association score of the new offer with shopper #4589, then active and/or passive feedback (to be used as the value of this attribute) is solicited from shopper #4589, perhaps by the ruse of including the possibly uninteresting new offer among several offers that the system presents to shopper #4589, in order to find out what shopper #4589 thinks of it. Once the root attribute is determined, the rapid profiling method descends the decision tree by one level, choosing one of the decision subtrees of the root in accordance with the determined value of the root attribute. The root of this chosen subtree considers another attribute of the new offer, whose value is likewise determined by an appropriate method. The process can be repeated to determine as many attributes of the new offer as desired, by whatever methods are available, although it is ordinarily stopped after a small number of attributes, to avoid the burden of determining too many attributes.

For another illustration, consider the case where new shoppers (rather than new offers) are profiled or partially profiled through the rapid profiling process. Suppose for the sake of example that each shopper profile includes an associative attribute that records the shoppers feedback on offers previously presented to the shopper. The rapid profiling procedure can rapidly form a rough characterization of a new shoppers preferences by soliciting the shopper's feedback on a small number of key offers, thereby determining the values of certain key attributes, and perhaps also by determining a small number of other key attributes (e.g., age) of the new shopper, by on line queries, telephone surveys, or other means. The attributes that are to be determined in this way are selected through the decision tree method described above. Once a new shopper has been partially profiled in this way, the methods disclosed above predict that the new shoppers preferences resemble the known preferences of other shoppers with similar profiles. In a variation, each shopper's shopper profile is subdivided into a set of long term attributes, such as demographic characteristics, and a set of short term attributes that help to identify the shopper's temporary shopping goals and emotional state, such as the shopper's textual or multiple choice answers to questions whose answers reflect the shopper's goals and mood. A subset of the shopper's long term attributes are determined when the shopper first registers with the system, through the use of a rapid profiling tree of long term attributes. In addition, each time the shopper logs on to the system, a subset of the shopper's short term attributes are additionally determined, through the use of a separate rapid profiling tree that asks about short term attributes. Because the shoppers goals and mood may vary during a shopping session, the latter step may be repeated from time to time, either at the shoppers initiative (e.g., the shopper elects to enter a shopping query that predicts his or her short-term attributes) or on the initiative of the shopping system.

Rapid profiling to determine a shoppers attributes is sometimes needed even for shoppers who are not new to the shopping system but have done little shopping of a particular type. A particular group of shoppers may agree on a choice of laundry detergent, while splitting fiercely—though consistently—on the subject of beer. To predict the beer preferences, it is necessary to consider subgroups. An established shopper may have a profile that places him clearly in the larger group, but that is not sufficiently complete to determine which subgroup he is in. Thus, when he attempts to buy beer on-line, it may be desirable to ask him a few additional questions about his beer preference, his hometown, or his college fraternity.

### Searching and Clustering of Similar Profiles

Using the Similarity Computation for Clustering

A method for defining the distance between any pair of profiles was disclosed above. Given this distance measure, it is simple to apply a standard clustering algorithm, such as k-means, to group a set of offers or shoppers into a number of clusters, in such a way that offers or shoppers with similar profiles tend to be grouped in the same cluster. This is used in several sections below, including the grouping of shoppers in the key section “Automatically selecting offers to maximize vendor profit” and in “Joint promotions”. The k means clustering method is familiar to those skilled in the art. Briefly put, it finds a grouping of points (profiles, in this case, whose numeric coordinates are given by numeric decomposition of their attributes as described above) to minimize the total of the squared distances between points in the clusters and the centers of the clusters in which they are located. This is done by alternating between assigning each point to the cluster which has the nearest center and then, once the points have been assigned, computing the (new) center of each cluster by averaging the coordinates of the points (profiles) located in this cluster. Other clustering methods can be used, such as “soft” or “fuzzy” k means clustering, in which offers (respectively shoppers) are allowed to belong to more than one cluster. This can be cast as a clustering problem similar to the k means problem, but now the criterion being optimized is a little different:

$$\sum {\sum }_{I} {i}_{{iC}_{C}} \times d ( {x}_{i} , {x}_{c} )$$

where C ranges over clusters, I ranges over offers (respectively shoppers), xᵢ is the numeric vector corresponding to the profile of offer or shopper number I, is the mean of all the numeric vectors corresponding to profiles of offers in cluster C, termed the “cluster profile” of cluster C, d(*, *) is the metric used to measure distance between two offer profiles, and i_{ic} is a value between 0 and 1 that indicates how much offer number I is associated with cluster number C, where I is an indicator matrix with the property that for each I:

$$\sum {i}_{{iC}_{C}} = 1$$

For k means clustering, every i_{ic} is required to be either 0 or 1. Any of these basic types of clustering might be used by the system:

1. Association based clustering, in which profiles contain only associative attributes (or non-associative attributes are ignored), and thus distance is defined entirely by associations. This kind of clustering generally (a) clusters offers based on the similarity of the shoppers who like them or (b) clusters shoppers based on the similarity of the offers they like. In this approach, the system does not need any information about offers or shoppers, except for their history of interaction with each other.

2. Content based clustering, in which profiles contain only non associative attributes (or associative attributes are ignored). This kind of clustering (a) clusters offers based on the similarity of their non associative attributes (such as price, size, or word frequencies) or (b) clusters shoppers based on the similarity of their non associative attributes (such as demographics and psychographics). In this approach, the system does not need to record any information about shoppers' historical patterns of information access, but it does need information about the intrinsic properties of shoppers and/or offers.

3. Uniform hybrid method, in which profiles may contain both associative and non associative attributes. This method combines (1a) and (2a), or (1b) and (2b). The distance d(Pₓ, P_{y}) between two profiles PX and PY may be computed by the general similarity measurement methods described earlier.

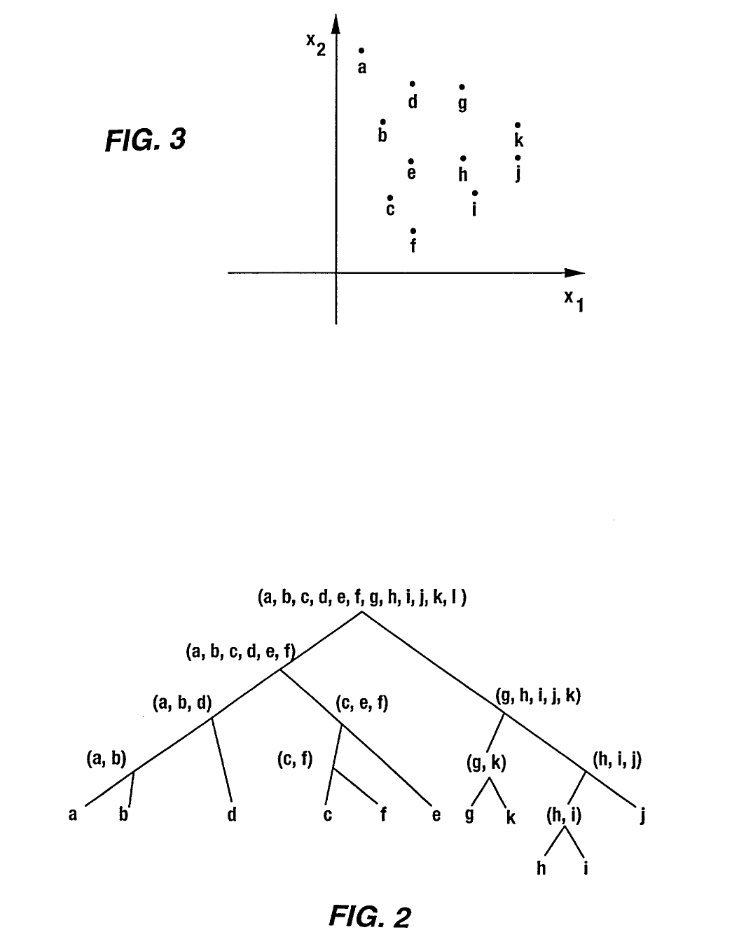

4. Sequential hybrid method. First apply the k means procedure to do (1a) above, so that offers are labeled by cluster based on which shoppers were interested in them, then use supervised clustering (maximum likelihood discriminant methods) using the offers' other attributes to do the process of method (2a) described above. This tries to use knowledge of who read what to do a better job of clustering based on word frequencies. One could similarly combine the methods (1b) and (2b) described above. Hierarchical clustering of offers is often useful. Hierarchical clustering produces a tree which divides the offers first into two large dusters of roughly similar offers; each of these clusters is in turn divided into two or more smaller clusters, which in turn are each divided into yet smaller clusters until the collection of offers has been entirely divided into “clusters” consisting of a single offer each, as diagramed in FIG. 2. In this diagram, the node d denotes a particular offer d, or equivalently, a single-member cluster consisting of this offer. Offer d is a member of the cluster (a, b, d), which is a subset of the cluster (a, b, c, d, e, f, which in turn is a subset of all offers. The tree shown in FIG. 2 would be produced from a set of offers such as those shown geometrically in FIG. 3. In FIG. 3, each letter represents an offer, and axes x1 and x2 represent two of the many numeric attributes on which the offers differ. Such a cluster tree may be created by hand, using human judgment to form clusters and subclusters of similar offers, or may be created automatically in either of two standard ways: top-down or bottom-up. In top-down hierarchical clustering, the set of all offers in FIG. 3 would be divided into the clusters (a, b, c, d, e, f) and (g, h, I, j, k). The clustering algorithm would then be reapplied to the offers in each cluster, so that the cluster (g, h, I, j, k) is subpartitioned into the clusters (g, k) and (h, I, j), and so on to arrive at the tree shown in FIG. 2. In bottom-up hierarchical clustering, the set of all offers in FIG. 3 would be grouped into numerous small clusters, namely (a, b), d, (c, f), e, (g, k), (h, I), and j. These clusters would then themselves be grouped into the larger clusters (a, b, d), (c, e, f), (g, k), and (h, I, j), according to their cluster profiles. These larger clusters would themselves be grouped into (a, b, c, d, e, f) and (g, k, h, I, j), and so on until all offers had been grouped together, resulting in the tree of FIG. 2. Note that for bottom-up clustering to work, it must be possible to apply the clustering algorithm to a set of existing clusters. This requires a notion of the distance between two clusters. The method disclosed above for measuring the distance between offers can be applied directly, provided that clusters are profiled in the same way as offers. It is only necessary to adopt the convention that a cluster's profile is the average of the offer profiles of all the offers in the cluster; that is, to determine the cluster's value for a given attribute, take the mean value of that attribute across all the offers in the cluster. For the mean value to be well defined, all attributes must be numeric, so it is necessary as usual to replace each textual or associative attribute with its decomposition into numeric attributes (scores), as described earlier. For example, the offer profile of a single Woody Allen film would assign “Woody Allen” a score of 1 in the “name of director” field, while giving “Federico Fellini” and “Terence Davies” scores of 0. A cluster of offers that consisted of 20 films directed by Allen and 5 directed by Fellini would be profiled with scores of 0.8, 0.2, and 0 respectively, because, for example, 0.8 is the average of 20 ones and 5 zeros.

### Determining Shoppers' Interest Through Similarity

Active and passive feedback only determine the shopper's interest in certain offers: namely, the offers that the shopper has actually had the opportunity to consider and provide feedback on. For offers that the shopper has not yet seen, the shopping system must estimate the shoppers interest in that offer, as a first step in estimating the shopper's likelihood of accepting that offer. This estimation task is at the heart of the shopping system, and the reason that the similarity measurement is important.

To state the problem more concretely, the shopping system periodically presents the shopper with various offers; the shopper may demonstrate more interest in some offers than in others, and may actually accept some of them. Thus the shopper provides active and/or passive feedback to the system relating to these presented offers. However, the system does not have feedback information from the shopper for offers that have never been presented to the shopper. For example, in the dating service domain, where offers come from prospective romantic partners, the system has only received feedback on old flames, not on prospective new loves. In order to determine which new offers to show the shopper, the system must be able to estimate the shopper's interest in them.

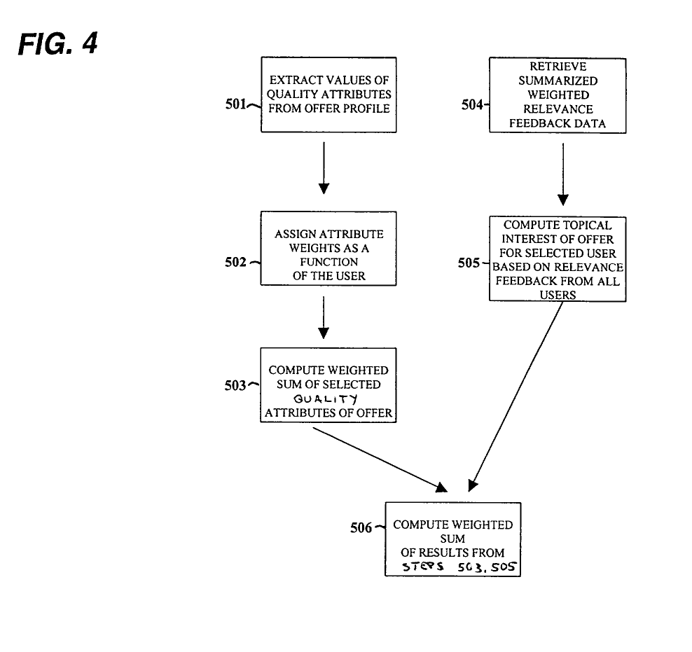

As shown in flow diagram form in FIG. 4, the evaluation of the interest in a particular offer by a specific shopper can be computed automatically. The interest r(U,X) that a given offer X holds for a shopper U is assumed to be a weighted average of two quantities: q(U, X), the intrinsic “quality” of X, and f(U, X), the “topical interest” that shoppers like U have in offers like X. Specifically, r(U,X)=Q*q (U,X) +(1-Q)*f(U,X), where Q is a real-valued parameter that is at least 0 and is less than 1. For any offer X, the intrinsic quality measure q(U, X) is easily estimated at steps 501-503 directly from numeric attributes of the offer X. (In an earlier section it was shown that a profile consisting of numeric, textual, and/or associative attributes could be transformed without loss of information to a profile consisting of numeric attributes only; this may be done here prior to applying the steps in FIG. 4.) The computation process begins at step 501, where the users of certain designated numeric attributes of offer X are specifically selected from offer X's offer profile, which attributes by their very nature should be positively or negatively correlated with shoppers' interest. Such attributes, termed “quality attributes,” have the normative property that the higher (or in some cases lower) their value, the more interesting a shopper is expected to find them. Quality attributes of offer X may include, but are not limited to, offer X's popularity among shoppers in general, the rating a particular reviewer has given offer X, the length of time offer X has already been available, the remaining time till offer X expires, the price of offer X, and the amount of money that the vendor making offer X has donated to a particular charity. At step 502, each of the selected attribute values for offer X is multiplied by a positive or negative weight, termed a “quality attribute weight,” which indicates the strength of shopper U's preference for those offers that have high values for the corresponding quality attribute. The quality attribute weights for shopper U are typically determined by retrieving a data file storing the quality attribute weights for the shopper U or for a group of shoppers similar to shopper U, but other methods may be used, including the simple method of disabling the quality ratings by taking all quality attribute weights to be zero.

At step 503, the sum of the identified weighted selected attributes is computed to determine the intrinsic quality measure q(U, X). At step 504, the summarized weighted relevance feedback data is retrieved, wherein some relevance feedback points are weighted more heavily than others and the stored relevance data can be summarized to some degree, for example by the use of search profile sets as described below. The more difficult part of determining shopper U's interest in offer X r(U,X) is to find or compute at step 505 the value of f(U, X), which denotes the topical interest that shoppers like U generally have in offers like X. The method of determining a shopper's interest relies on the following heuristic: when X and Y are similar offers (have similar attributes), and U and V are similar shoppers (have similar attributes), then topical interest f(U, X) is predicted to have a similar value to the value of topical interest f(V, Y). This heuristic leads to an effective method because estimated values of the topical interest function f(*, *) are actually known for certain arguments to that function: specifically, if shopper V has provided a feedback rating of ˜r(V, Y) for offer Y, then insofar as that rating represents shopper V's true interest in offer Y, we have ˜r(V, Y)=Q*q(V, Y)+ (1-Q)*f(V, Y) and can estimate f(V, Y) as (˜f(V, Y) Q*q(V, Y))/(1-Q). Thus, the problem of estimating topical interest at all points becomes a problem of interpolating among these estimates of topical interest at selected points, such as the feedback estimate of ˜f(V, Y)=(˜r(V, Y) Q*q(V, Y))/(1-Q), at points (V, Y) where feedback ˜r(V, Y) is known.

This interpolation can be accomplished with any standard smoothing technique, using as input the known point estimates of the value of the topical interest function f(*, *), and determining as output a function that approximates the entire topical interest function f(*, *). To effectively apply such a smoothing technique, it is usually necessary to have a definition of the similarity distance between (U, X) and (V, Y), for any shoppers U and V and any offers X and Y. We have already seen how to define the distance d(X, Y) between two offers X and Y, given their attributes. We may regard a pair such as (U, X) as an extended object that bears all the attributes of offer X and all the attributes of shopper U; then the distance between (U, X) and (V, Y) denoted d (U, X), (V, Y), may be computed in exactly the same way.

Not all point estimates of the topical interest function f(*, *) should be given equal weight as inputs to the smoothing algorithm. Since passive feedback is less reliable than active feedback, point estimates made from passive feedback should be weighted less heavily than point estimates made from active feedback, or even not used at all. In some domains, a shopper's interests may change over time and, therefore, estimates of topical interest that derive from more recent feedback should also be weighted more heavily. A shopper's interests may vary according to mood, so estimates of topical interest that derive from the current session should be weighted more heavily for the duration of the current session, and past estimates of topical interest made at approximately the current time of day or on the current weekday should be weighted more heavily. Finally, in domains where shoppers are trying to locate offers of long term interest (automobiles, investments, romantic partners, pen pals, employers, employees, suppliers, service contracts) from the possibly meager information provided by the offer profiles, the shoppers are usually not in a position to provide reliable immediate feedback on an offer, but can provide reliable feedback at a later date. An estimate of topical interest f(V, Y) should be weighted more heavily if shopper V has had more experience with offer Y. Indeed, a useful strategy is for the system to track long term feedback for such offers. For example, if offer profile Y was created in 1990 to describe a particular investment that was available in 1990, and that was purchased in 1990 by shopper V, then the system solicits relevance feedback from shopper V in the years 1990, 1991, 1992, 1993, 1994, 1995, etc., and treats these as successively stronger indications of shopper V's true interest in offer profile Y, and thus as indications of shopper V's likely interest in new investments whose current profiles resemble the original 1990 offer profile Y. In particular, if in 1994 and 1995 shopper V is well disposed toward his or her 1990 purchase of the investment described by offer profile Y, then in those years and later, the system tends to recommend additional investments when they have profiles like offer profile Y, on the grounds that they too will turn out to be satisfactory in 4 to 5 years. It makes these recommendations both to shopper V and to shoppers whose investment portfolios and other attributes are similar to shopper V's. The relevance feedback provided by shopper V in this case may be either active (feedback=satisfaction ratings provided by shopper V) or passive (feedback=difference between average annual return of the investment and average annual return of the Dow Jones index portfolio since purchase of the investment, for example).

For some domains, when estimating topical interest, it is appropriate to make an additional “presumption of no topical interest” (or “bias toward zero”). To understand the usefulness of such a presumption, suppose the system needs to determine whether offer X is topically interesting to the shopper U, but that shoppers like shopper U have never provided feedback on offers even remotely like offer X. The presumption of no topical interest says that if this is so, it is because shoppers like shopper U are simply not interested in such offers and therefore do not seek them out or otherwise consider them. On this presumption, the system should estimate topical interest f(U, X) to be low. Formally, this example has the characteristic that (U, X) is far away from all the points (V, Y) where feedback is available. In such a case, topical interest f(U, X) is presumed to be close to zero, even if the value of the topical interest function f(*, *) is high at all the faraway surrounding points at which its value is known. When a smoothing technique is used, such a presumption of no topical interest can be introduced, if appropriate, by manipulating the input to the smoothing technique. For example, one technique for manipulating the input not only uses the observed values of the topical interest function f(*, *) as input, but also introduces fake observations of the form topical interest f(V, Y)=0 for a lattice of points (V, Y) distributed throughout the multidimensional space. These fake observations should be given relatively low weight as inputs to the smoothing algorithm. The more strongly they are weighted, the stronger the presumption of no interest.

The following provides another simple example of an estimation technique that has a presumption of no topical interest. Let g be a decreasing function from non-negative real numbers to non-negative real numbers, such as g(x)=e^{-x} or g(x) =(x+1)^{-k} where k>0. Estimate topical interest f(U, X) with the following g-weighted average:

f(U, X)=Σg (d ((U, X) (V, Y)))˜f(V, Y)

Here the summations are over all pairs (V, Y) such that shopper V has provided feedback r(V, Y) on offer Y, i.e., all pairs (V, Y) such that relevance feedback ˜r(V, Y) is defined. Note that both with this technique and with other conventional smoothing techniques, the smoothed estimate f (V, Y) is not necessarily equal to ˜f (V, Y) at points where the latter is defined.

### Adjusting Weights and Residue Feedback

The method described above requires the filtering system to measure distances between (shopper, offer) pairs, such as the distance between (U, X) and (V, Y). Given the means described earlier for measuring the distance between two multi attribute profiles, the method must associate an attribute weight, called wk for the kth attribute, with each attribute used in the profile of (shopper, offer) pairs, that is, with each attribute used to profile either shoppers or offers. These attribute weights specify the relative importance of the attributes in establishing similarity or difference, and therefore, in determining how topical interest is generalized from one (shopper, offer) pair to another. Additional weights, called quality attribute weights, determine which attributes of an offer contribute to the quality function q, and by how much.

It is possible and often desirable for a filtering system to store a different set of attribute weights and/or a different set of quality attribute weights for each shopper. The weights stored for a given shopper are used when selecting or clustering offers of interest to that shopper (though typically not when performing clustering operations on multiple shoppers or on (shopper, offer) pairs involving multiple shoppers). For example, a shopper who thinks of two star films as having materially different topic and style from four star films wants to assign a high attribute weight to “number of stars” for purposes of determining the similarity distance measure d(*,*); this means that interest in a two star film does not necessarily signal interest in an otherwise similar four star film, or vice versa. If the shopper also agrees with the critics, and actually prefers four star films, the shopper also wants to assign “number of stars” a high positive quality attribute weight for purposes of determining of the quality function q. In the same way, a shopper who dislikes vulgarity wants to assign the “vulgarity score” attribute a strongly negative quality attribute weight in the determination of the quality function q, although the “vulgarity score” attribute does not necessarily have a high attribute weight in determining the topical similarity of two films. It should be noted that shoppers and offers are symmetric, in that just as weights for a particular shopper may be maintained and used to select offers of interest to that shopper, weights for a particular offer may be maintained and used to select shoppers who are likely to be interested in that offer. Although the discussion is written in terms of the former case, the latter case may be implemented in exactly the same way.

Attribute weights and quality attribute weights may be set or adjusted by the system administrator or the individual shopper, on either a temporary or a permanent basis. However, it is often desirable for the filtering system to learn attribute weights and/or quality attribute weights automatically, based on relevance feedback. The optimal weights for a shopper U are those that allow the most accurate prediction of shopper U's interests. That is, with the distance measure and quality function defined by these attribute weights, shopper U's interest in offer X, r(U, X)=Q*q(U, X)+(1-Q)*f(U, X), can be accurately estimated by the techniques above. The effectiveness of a particular set of attribute weights for shopper U can therefore be gauged by seeing how well it predicts shopper U's known interests.

Formally, suppose that shopper U has previously provided feedback on offers X₁, X₂, X₃, . . . Xₙ, and that the feedback ratings are ˜r(U, X₁), ˜r(U, X₂), ˜r(U, X₃), . . . ˜r(U, Xₙ). Values of feedback ratings ˜r(*,*) for other shoppers and other offers may also be known. The system may use the following procedure to gauge the effectiveness of the set of attribute weights it currently stores for shopper U: (1) For each I such that (<=I<=n), use the estimation techniques to estimate r(U, X) from all known values of feedback ratings ˜r. Call this estimate ai. (2) Repeat step (1), but this time make the estimate for each I without using the feedback ratings ˜r(U, Xⱼ) as input, for any j such that the distance d(Xᵢ, Xⱼ) is smaller than a fixed threshold. That is, estimate each r(U, Xᵢ) from other values of feedback rating ˜r only; in particular, do not use ˜r(U, Xᵢ) itself. Call this estimate bᵢ. The difference a_{I}-bᵢ I bᵢ s herein termed the “residue feedback ˜rᵣₑₛ(U, Xᵢ) of shopper U on offer Xᵢ.” (3) Compute shopper U's error measure, (a₁-b₁)²+(a₂-b₂)² +(a₃-_b₃)²+ . . . +(aₙ-bₙ)².

A gradient descent or other numerical optimization method may be used to adjust shopper U's attribute weights and/or quality attribute weights so that this error measure reaches a (local) minimum. This approach tends to work best if the smoothing technique used in estimation is such that the smoothed estimate f(V, Y) is strongly affected by the point estimate ˜f(V, Y)=≈˜r(V, Y)-Q.q(V, Y))/(1-Q) when the ˜r(V, Y) is provided as input. Otherwise, the presence or absence of the single input feedback rating r(U, Xi), in steps (I) (ii) may not make ai and bi very different from each other. A slight variation of this learning technique adjusts a single global set of attribute weights for all shoppers, by adjusting the weights so as to minimize not a particular shopper's error measure but rather the total error measure of all shoppers. These global weights are used as a default initial setting for a new shopper who has not yet provided any feedback. Gradient descent can then be employed to adjust this shopper's individual weights over time. Even when the attribute weights are chosen to minimize the error measure for shopper U, the error measure is generally still positive, meaning that residue feedback from shopper U has not been reduced to 0 on all offers. It is useful to note that high residue feedback from a shopper U on an offer X indicates that shopper U liked offer X unexpectedly well given its profile, that is, better than the smoothing model could predict from shopper U's opinions on offers with similar profiles. Similarly, negative residue feedback indicates that shopper U liked offer X less than was expected. By definition, this unexplained preference for or against offer X cannot be the result of topical similarity, and therefore must be regarded as an indication of the intrinsic quality of offer X. It follows that a useful quality attribute for an offer X is the average amount of residue feedback rres(V, X) from shoppers on that offer, averaged over all shoppers V who have provided relevance feedback on the offer. In a variation of this idea, residue feedback is never averaged indiscriminately over all shoppers to form a new attribute of an offer, but instead is smoothed to consider shoppers' similarity to each other. Recall that the quality measure q(U, X) depends on the shopper U as well as the offer X, so that a given offer X may be perceived by different shoppers to have different quality. In this variation, as before, q(U, X) is calculated as a weighted sum of various quality attributes that are dependent only on X, but then an additional term is added, namely an estimate rᵣₑₛ(U, X) of ˜rᵣₑₛ (U, X) found by applying a smoothing algorithm to known values of ˜rᵣₑₛ(V, X). Here V ranges over all shoppers who have provided relevance feedback on offer X, and the smoothing algorithm is sensitive to the distances d(U, V) from each such shopper V to shopper U.

### Using Offer Demand Summaries to Estimate Shoppers' Interest

In the above method, it is not necessary that ˜r(V,Y) be stored exactly for each (V,Y) pair such that shopper V has provided feedback on offer Y. For the method to work it is only necessary to approximate the shape of the (smoothed) r(*,*) function, so any approximation to the known ˜r(*,*) function or the extrapolated (smoothed) function r(*,*) may be stored, in order to save space or computation time. Alternatively, an approximation to the smoothed f(*,*) function may be stored, where f(V,Y)=(r(V,Y)-Q*q(V,Y))/(1-Q). In one variation, for each shopper V, an approximation to f(V,*) is stored; this is called an offer demand summary for shopper V. In this variation, wherever the value of f(V,Y) is needed in the method above, the offer demand summary for shopper V is retrieved, if necessary, and the approximate value of f(V,Y) is used instead of a stored exact value for ˜f(V,Y). Wherever the value of ˜r(V,Y) is needed in the method above, it is computed by first finding the approximate value of ˜f(V,Y) in exactly the same way, and adding to this the value of stet q(V,Y). One embodiment of an offer demand summary for a given shopper V is a set of search profiles for shopper V, each of which indicates a type of offer that shopper V likes. The estimated value of f(V,Y) for an offer Y with offer profile P_{y} is then given by max ˜f(V, Sᵥᵢ) 1+d(P_{y}, Sᵥᵢ) where Sᵥᵢ ranges over shopper V's search profiles and where ˜f(V, Svi) has been previously computed to each search profile Sᵥᵢ using the method disclosed above or simply set to 1 or some other estimate, and is shared with search profile Sᵥᵢ. A more sophisticated variation instead uses the formula:

$$f ( V , Y ) max \approx \sim f ( V , {S}_{Vi} ) \frac{I}{{d}_{V} ( {P}_{Y} , {S}_{Vi} )}$$

where the function dᵥ(*,*) is defined similarly to the distance function d(*,*), above, but instead of using the global weights for offer attributes, uses a vector of attribute weights w_{V} that is specialized for the shopper V, and records the importance for the similarity computation of the various attributes that appear in offer profiles, when such similarity computation is performed in order to cluster or select offers for shopper V. For example, wᵥⱼ is the weight of attribute j for shopper V. Specifically, just as we defined, using a global vector w of attribute weights, we now define:

$${d}_{V} ( {P}_{X} , {P}_{Y} ) = {( {\sum }_{k} {( {d}_{k} ( {P}_{Xk} , {P}_{Yk} ) {w}_{Vk} )}^{6} )}^{1 / s}$$

using the shopper-specific vector wᵥ of attribute weights. This attribute weight vector w_{V} specifies only a single attribute weight for each numeric, textual or associative attribute in; a textual or associative attribute is not regarded for this purpose as being decomposed into numeric attributes. (By contrast, each search profile does specify values for all the numeric attributes that compose a textual or associative attribute, because this is necessary in order to measure the similarity between a search profile and an offer profile.) The weight vector wᵥ must be stored (along with the search profile set) as part of shopper V's offer demand summary. In a further variation, the term:

$$\frac{1}{1 + d ( {P}_{Y} , {S}_{Vi} )} ( respectively \frac{1}{1 + {d}_{V} ( {P}_{Y} , {S}_{Vi} )}$$

in the above formulas may be replaced by any other term that decreases with the distance d(P_{y}, Sᵥᵢ) (respectively dᵥ( P_{y}, Sᵥᵢ)), such as the value of a Gaussian function applied to this distance. In a further variation, the approximation to f(V, Y) may be found by summing over multiple search profiles Sᵥᵢ of shopper V rather than by maximizing over them. The search profile set (and weight vectors, if any), associated with a given shopper changes over time. The search profile set can be initially determined for a new shopper by any of a number of procedures, including the following preferred methods: (1) asking the shopper to specify search profiles directly by giving keywords and/or numeric attributes, (2) using as search profiles the offer profiles of offers, or the cluster profiles of clusters of offers, that the shopper indicates are representative of his or her interest, (3) using a standard set of search profiles copied or otherwise determined from the search profile sets associated with shoppers who are similar to the given shopper. Search profiles determined by any of these methods may also be constructed for shoppers who are not new, either automatically or at a shopper's request; each such search profile S' may then be used to update such a shoppers search profile set by any of a number of methods, including (1) adding it to the shopper's search profile set and (2) replacing the search profile S from the shoppers search profile set that minimizes d(S,S') with the weighted-average profile a*S +(1-a)*S', for some real number a between 0 and 1 inclusive. Such updating may be appropriate if a shoppers interests have changed, or in order to give the shopper the advantage of the search profiles accumulated by similar shoppers, in order to compensate for sparse data.

If shoppers' offer demand summaries also include attribute weight vectors, these attribute weight vectors may be initialized for a new shopper either by asking the shopper to specify them directly, or by using a standard weight vector copied or otherwise determined from the attribute weight vectors associated with shoppers who are similar to the new shopper. As with search profiles, such an attribute weight vector w′ may also be constructed for an existing shopper, may be used to update the shopper's existing attribute weight vector w, for example by replacing w with a*w+(1-a)*w′ for some real number a between 0 and I inclusive.

Shoppers' search profile sets can be updated using the method described in U.S. Pat. No. 5,758,257. When a shopper Vs feedback rating for an offer X becomes known or is changed, for example because the shopper has accepted offer X, the device that is responsible for updating the shopper's profile also shifts one or more search profiles in the shoppers search profile set slightly toward or away from offer X's offer profile Pₓ. Let S be the search profile in the shopper's search profile set that is closest to offer profile Pₓ, i.e., that minimizes the distance d( Pₓ, S). Recall that S and Pₓ can each be regarded as a numeric vector of offer attributes. In a preferred method, S is replaced by the new search profile whose numeric vector is given by S+e( Pₓ-S), where e is a scalar value. If e is positive, this adjustment increases the similarity of the search profile to Pₓ. The size of e determines the size of the adjustment, and therefore affects the system's learning rate. If e is too large, the algorithm becomes unstable, but for sufficiently small e, the search profile set gradually becomes more indicative of the shopper's preferences. In general, e should increase somewhat with the degree to which the shopper V expressed more interest in the offer X than would be expected from the estimate of r(V, X); that is, other things equal, e should be a function of two arguments, shopper V's feedback on offer X and the previous estimate of r(V,X), such that e increases on its first argument and decreases on its second argument. Note that e may be negative, if the shopper likes the offer less than expected. If e is negative, updating search profile S as described will make it less like offer profile Pₓ, but usually we prefer to suppress the update of search profile S when e<0, since there is no guarantee that updating search profile S in this case will make it more similar to profiles of offers that the shopper does like.

If shopper V's offer demand summary includes an attribute weight vector wᵥ, the above method for updating search profile sets should be modified to use the shopper-specific distance measure dᵥ(*,*) rather than the global distance measure d(*,*). In addition, the weight vector wᵥ should be adjusted along with S, by replacing each weight w_{Vk} in the vector with:

$$\frac{{w}_{Vk} - e \times {d}_{k} ( {P}_{Xk} , {S}_{k} )}{{\sum }_{k} {w}_{Vk} - e \times {d}_{k} ( {P}_{Xk} , {S}_{k} )}$$

where e is computed exactly as for the adjustment of S, w_{Vk} denotes the weight that shopper V places on the kth attribute of offer profiles, P_{Xk} denotes the value of the kth attribute of the offer profile P_{Xk}, Sₖ similarly denotes the value of the kth attribute of the search profile S, and dₖ(*,*) is the distance function for the kth attribute of offer profiles (the same dk(*,*) that was used earlier to define the distances d(*,*) and dᵥ (*,*) between entire offer profiles). If e>0, this procedure reduces the influence of attributes that make Pₓ dissimilar to S. Unlike the procedure for adjusting S, we always make the adjustment to w_{V} even when e<0, in which case it increases the influence of attributes that make Pₖ dissimilar to S. The denominator of the expression prevents weights from shrinking to zero over time, by renormalizing the modified weights so that they sum to one. Further variations are possible on the theme of weight vectors: Rather than having a separate weight vector wV for every shopper V, it is possible to use a separate weight vector wᵥₛ for every combination of a shopper V and a search profile S in shopper V's search profile set. Then when computing the distance between S and an offer X, one would use a distance function weighted by wᵥₛ, and wᵥₛ would be adjusted whenever S was adjusted. It is possible to change not only the attribute weights that determine profile similarity, but also the term weights or association weights that are used to define attribute similarity. Recall that when attribute k is an textual (respectively associative) attribute, the definition of the attribute distance function dₖ(*,*), used above, depends on term weights (respectively association weights) for the many terms (respectively associations) whose scores constitute attribute k. In a variation of the method just described for storing and updating shopper V's weight vector wᵥ, shopper V's offer demand summary may include an additional vector w′_{Vk} of term weights, for each textual attribute k, and an additional vector w′_{Vk} of association weights, for each associative attribute k. Then for each textual or associative attribute k, we may define the distance function d_{Vk}(*,*), a version of dₖ(*.*) that is specialized to this shopper in that it uses shopper V's term weights or association weights w′_{Vk}. Given these definitions, we may redefine dᵥ(*,*) to use both the new attribute distance functions d_{Vk}(*,*) together with the previously-discussed attribute weights wᵥ, by taking a weighted combination of the two contributions. The weights w′_{Vk} may be initialized by any of the methods described earlier for choosing term weights and association weights. They should always be adjusted immediately before the weights w_{Vk} are adjusted, by replacing each weight w in each vector w′_{Vk} with

$$\sum \frac{{w}_{Vkj}^{′} - {b}_{k} e \times \vert {P}_{Xkj} - {S}_{kj} \vert}{{w}_{Vkj}^{′} - {b}_{k} e \times \vert {P}_{Xkj} - {S}_{kj} \vert}$$

where bₖ is a scalar that affects the learning rate for the term weights or association weights of attribute k, e is determined as before, and P_{Xkj} and Sₖⱼ are the jth term score or association score in the kth attribute of the profiles Pₓ and S, respectively.

As described earlier, it is also possible to adjust quality attribute weights on a per-shopper basis. That is, shopper V's offer demand summary may be augmented with a shopper-specific vector of quality attribute weights, Wᵥ, which is used in defining the computation q(V,*), as described earlier; here w_{Vk}=0 for any attribute k that is not a quality attribute. These quality attribute weights may be adjusted by a similar procedure: when search profiles are adjusted as described above because shopper V's feedback on offer X became known, the quality attribute weight vector W_{V} may be adjusted to increase or decrease the quality rating q(V,X), which is defined by: Σw′_{VkXk}.

This is done by the gradient-descent technique of replacing each quality attribute weight W_{Vk} with w′_{Vk} replaced by:

$$\sum \frac{{w}_{Vkj}^{′} - {b}_{k} e \times \vert {P}_{Xkj} - {S}_{kj} \vert}{{w}_{Vkj}^{′} - {b}_{k} e \times \vert {P}_{Xkj} - {S}_{kj} \vert}$$

where e is computed as before and c is a real number that affects the learning rate for the quality attribute rates. The parameter Q, which determines the relative importance of the quality rating in computing the relevance rating r(V,X), may also be adjusted when w_{Vk} is adjusted, by replacing Q with Q+c′e(q(V,X)-f(V,X)), where e is computed as before and c′ is a real number that affects the learning rate for Q. As when adjusting w_{V}, W_{V} and Q should be adjusted according to this procedure even when e<0.

### Searching for Offers

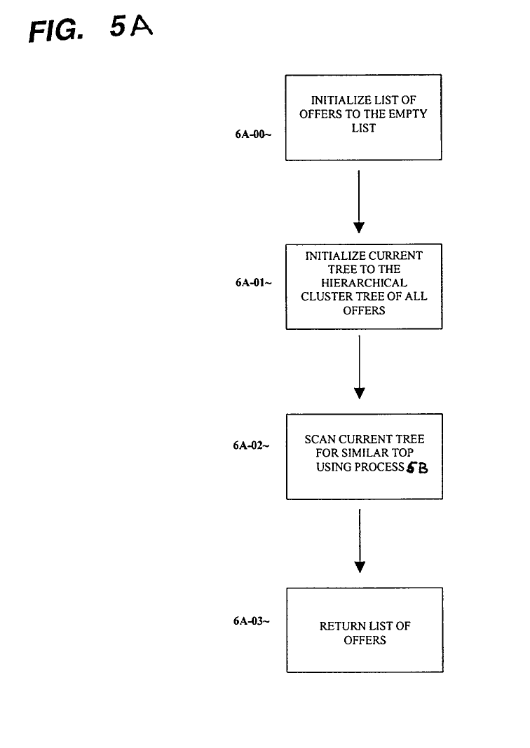

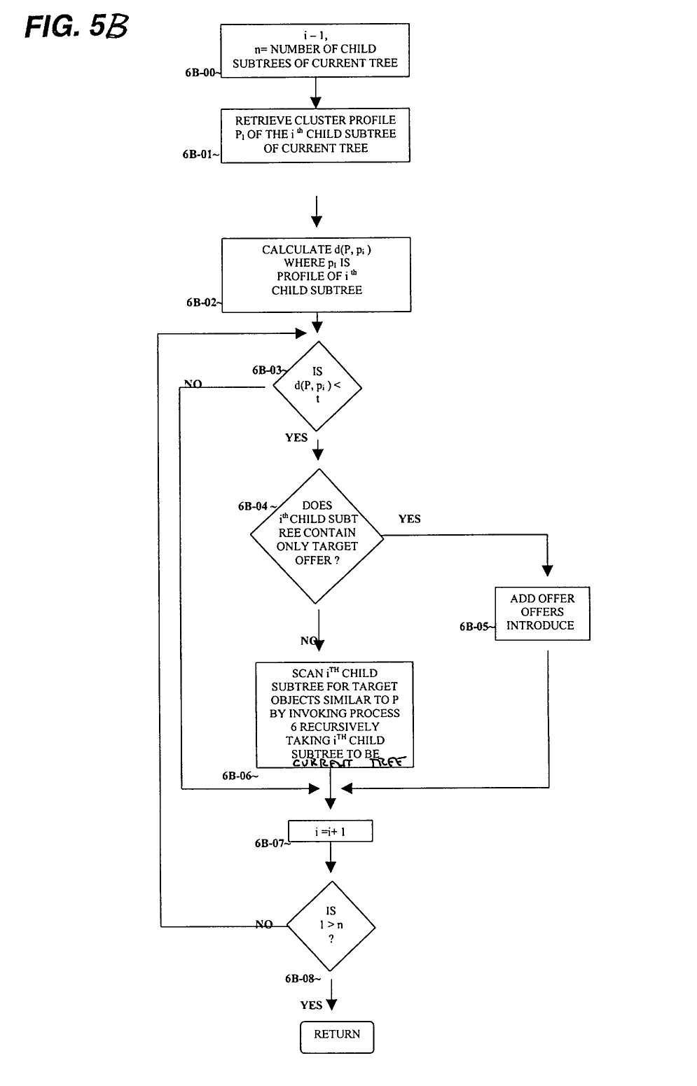

Given an offer with offer profile P, or alternatively given a search profile P, a hierarchical cluster tree of offers makes it possible for the system to search efficiently for offers with offer profiles similar to P. It is only necessarily to navigate through the tree, automatically, in search of such offer profiles. The clustering subsystem begins by considering the largest, top level clusters, and selects the cluster whose profile is most similar to offer profile P. In the event of a near tie, multiple clusters may be selected. Next, the system considers all subclusters of the selected clusters, and this time selects the subcluster or subclusters whose profiles are closest to offer profile P. This refinement process is iterated until the clusters selected on a given step are sufficiently small; these are then the desired clusters of offers with profiles most similar to offer profile P. Any hierarchical cluster tree therefore serves as a decision tree for identifying offers. In pseudo code form, this process is as follows (and in flow diagram form in FIGS. 5A and 5B):

1. Initialize list of identified offers to the empty list at step 6A00.

2. Initialize the current tree T to be the hierarchical cluster tree of all offers at step 6A01 and at step 6A02 scan the current cluster tree for offers similar to P, using the process detailed in FIG. 5B. At step 6A03, the list of offers is returned. Step 6A02 has the following substeps, as shown in FIG. 5B:

0. At step 6B00, the variable I is set to 1.

1. At step 6B01, the cluster profile P1 of the ith child sub tree of the current tree is retrieved.

2. At step 6B02, calculate d(P, pi), the similarity distance between P and cluster profile.

3. At step 6B03, if d(P, pi)<t, a threshold, branch to one of two options

4a. If tree Ti contains only one offer at step 6B04, add that offer to list of identified offers at step 6B05 and advance to step 6B07.

4b. If tree Ti contains multiple offers at step 6B04, scan the ith child subtree for offers similar to P by invoking the steps of the process of FIG. 5B recursively and then recurse to step 0 (step 6B00) with T bound for the duration of the recursion to tree Ti, in order to search in tree Ti for offers with profiles similar to P.

7. I Usenet I, the count of which child subtree is being examined, by one.

8. If no more subtrees remain, terminate the process, otherwise go back to step 1 and continue with the next subtree.

In step 5 of this pseudo code, smaller thresholds are typically used at lower levels of the tree, for example by making the threshold t an affine function or other function of the cluster variance or cluster diameter of the cluster pi. If the storage of the cluster tree is distributed across a plurality of servers, this process may be executed in distributed fashion as follows: steps 3 7 are executed by the server that stores the root node of hierarchical cluster tree T, and the recursion in step 7 to a subcluster tree Ti involves the transmission of a search request to the server that stores the root node of tree Ti , which server carries out the recursive step upon receipt of this request. Steps 1 2 are carried out by the processor that initiates the search, and the server that executes step 6 must send a message identifying the offer to this initiating processor, which adds it to the list.

Assuming that low level clusters have been already been formed through at least one level of clustering, there are alternative search methods for identifying the low level cluster whose profile is most similar to a given offer profile P. A standard back propagation neural net is one such method: it should be trained to take the attributes of an offer as input, and produce as output a unique pattern that can be used to identify the appropriate low level cluster. For maximum accuracy, low level clusters that are similar to each other (close together in the cluster tree) should be given similar identifying patterns. Another approach is a standard decision tree that considers the attributes of offer profile P one at a time until it can identify the appropriate cluster. If profiles are large, this may be more rapid than considering all attributes. A hybrid approach to searching uses distance measurements as described in FIGS. 5A and 5B to navigate through the top few levels of the hierarchical cluster tree, until it reaches an cluster of intermediate size whose profile is similar to offer profile P, and then continues by using a decision tree specialized to search for low level subclusters of that intermediate cluster.

One use of these searching techniques is to search for offers that match a search profile from a shopper's search profile set. Another use is to add a new offer quickly to a hierarchical cluster tree of many offers. An existing cluster in the tree that is similar to the new offer can be located rapidly, and the new offer can be added to this cluster. If the offer profile is beyond a certain threshold distance from the cluster profile of this similar cluster, then it is advisable to start a new cluster containing only the new offer, or in a variation to add the new offer to the cluster but then to recluster the offers in the cluster. Several variants of this incremental clustering scheme can be used, and can be built using variants of subroutines available in advanced statistical packages. Note that various methods can be used to locate the new offers that must be added to the cluster tree, depending on the architecture used. In our preferred method, whenever a new offer is added to the offer database, the main computer calculates the offer profile and adds it to the hierarchical cluster tree by the above method. To ensure accuracy, periodically all or part of the cluster tree may be destroyed and recreated by applying a clustering algorithm to the offers in that part of the cluster tree. The system description in the above noted U.S. Pat. No. 5,758,257 suggests use of preclustering to enhance performance and better enable a scalable system. We may also improve scaleability by other methods such as principal components factor analysis.

### Clustering of Items with Multiple Attributes

We showed above that grouping people into clusters based on the items they have purchased allows accurate recommendations of new items for purchase: if you and I have liked many of the same movies, then I will probably enjoy other movies that you like. We also showed how such clustering can be used to select price points and promotions.

Recommending items based on similarity of interest (a.k.a. collaborative filtering) is attractive for many domains: books, CDS, movies, etc., but does not always work well. Because data are always sparse—any given person has seen only a small fraction of all movies—much more accurate predictions can be made by grouping people into clusters based on their having similar purchase patterns and grouping purchase items into clusters which tend to be liked by the same people. Finding optimal clusters is tricky because the item groups should be used to help determine the people groups and visa versa. We present a formal statistical model of collaborative filtering, and introduce a set of algorithms for estimating the model parameters.

The method proposed below has many advantages. It can easily be extended to handle missing data. Most importanly, it can easily handle the case of multiple clusters: e.g. simultaneously clustering people, movies, directors, and actors. This is particularly important for clustering data from relational databases. Many marketing data bases take this form: people have attributes (e.g. state they reside in and occupation) which can be clustered in their own right. Similarly, items offered for purchase have attributes such as brand which may warrant clustering. Databases rarely have sufficient coverage to allow accurate recommendations without some form of clustering people and/or items based on their attributes.

In this section we present a method for simultaneous clustering of people and items with attributes. We use the case of movies for concreteness, but it will be obvious that such simultaneous multiple clustering is often important: one may wish to group shoppers, items and manufacturers, or to group shoppers and ads, where ads have items being sold, types of promotions and price points.

To illustrate the major classes of methods available, consider a data base containing people and movies:

| person | age | movie |
|---|---|---|
| A: | x1 | x2 = C |
| B: | x1 | x2 = D |

| movie director | male lead | female lead |
|---|---|---|
| C: | x3 | x4 |
| D: | x3 | x5 |

One could unfold (extend) the table to include all the attributes of the movies:

A: ×1 ×2 ×3 ×4 ×5

B: ×1 ×2 ×3 ×4 ×5

but this is very inefficient. Different objects have different fields, so the extended table may have large numbers of empty fields. Also, the extended table neglects the correlation structure within the objects: it does not know that every instance of Starwars is directed by George Lucas and starred Harrison Ford.

An alternate approach is to cluster the sub-objects first. This works well on relatively simple problems, but is less effective for more complex domains where people are in many clusters (e.g. people read many kinds of books) and the object attributes do not lead to clean clusters (e.g. the same actor is in both dramas and comedies). In these cases, a simultaneous statistical model can be superior. Before considering the full simultaneous clustering problem, look first at the simpler two cluster problem.

We propose the following model of collaborative filtering: People and movies are from classes. For example, movies are action, foreign or classic (with real data, we would use hundreds of classes). People are also from classes: e.g., intellectual or fun. These classes are unknown, and must be derived as part of the model estimation process. We will eventually use a range of information to derive these classes, but initially, let us ask how far we can get just using links. To see this more concretely, rearrange the person × movie table we saw before:

| | Batman | Rambo | Andre | Hiver | Whispers | Starwars |
|---|---|---|---|---|---|---|
| Lyle | | | y | | y | y |
| Ellen | | | y | y | y | |
| Jason | | | y | y | | y |
| Fred | y | y | | | | y |
| Dean | y | y | | | | y |

There appears to be a group of people Lyle, Ellen, Jason who like certain movies Andre, Hiver, Whispers. and another group Fred, Dean who like other movies Batman, Rambo. Almost everyone likes a third group of movies Starwars. For each person/movie class pair, there is a probability that there is a “yes” in the table:

| | action | foreign | classic |
|---|---|---|---|
| intellectual | 0/6 | 5/9 | 2/3 |
| fun | 3/4 | 0/6 | 2/2 |

The above insight can be made into a formal generative model of collaborative filtering. It is useful to think first of how the data are generated, and then later of how one might best estimate the parameters in the model. The generative model assures a clean, well-specified model. We assume the following model:

randomly assign each person to a class k

randomly assign each movie to a class l

for each person/movie pair,

assign a link with probability Pkl The model contains three sets of parameters:

Pk=probability a (random) person is in class k

Pl=probability a (random) movie is in class l

Pkl=probability a person in class k likes a movie in class l The first two are just the base rates for the classes: what fraction of people are in a given class. The latter, Pkl are the numbers estimated in table 3.

### Solution Methods

1. Repeated clustering

One method of addressing this problem is to cluster people and movies separately, e.g. using K-means clustering, which approximates the EM. One can cluster people based on the movies they watched and then cluster movies based on the people that watched them. The people can then be re-clustered based on the number of movies in each movie cluster they watched. Movies can similarly be re-clustered based on the number of people in each person cluster that watched them. Unfortunately, it is not immediately obvious whether repeated clustering will help or hurt. Clustering on clusters provides generalization beyond individual movies to groups, and thus should help with sparse data, but it also “smears out” data, and thus may over-generalize.

2. Gibbs Sampling

One might wish to update one person or movie at a time to avoid constraint violation, but updating one person in EM changes nothing. One cannot move just one person, since this would lead to a constraint violation. Gibbs sampling offers a way around this dilemma by sampling from distributions rather than finding the single most likely model. Gibbs sampling is a Bayesian equivalent of EM and, like EM, alternates between two steps:

Assignment

pick a person or movie at random

assign to a class proportionally to probability of the class generating them

Model estimation

pick Pk, Pl, Pkl with probability

proportional to likelihood of their

generating the data Gibbs sampling is guaranteed to converge to the true distribution, but need not do so quickly.

A generative model is easily constructed for the full multiple cluster problem. A simple model might be of the form: (1) randomly assign each person, movie and actor to a class k and (2) for each person/movie/actor triple, assign a link with probability Pklm. More complex models are easily built. The Gibbs sampling presented above is trivially extended to estimate these new models.

In summary, collaborative filtering is well described by a probabilistic model in which people and the items they view or buy are each divided into (unknown) clusters and there are link probabilities between these clusters. Clustering items or people on other relevant attributes can—and often does increase prediction accuracy. Gibbs sampling works well and has the virtue of being easily extended to much more complex models, but is computationally expensive for larger data sets.

### System Descriptions

Automatically Selecting Offers to Maximize Vendor Profit

The same product, with no change in features or brand label, may be variously offered under different advertisements and different prices. That is, the same product may correspond to many possible offers, each with its own offer profile. Broadly speaking, however, only one of these offers should be made to a given shopper at a given time, and it is advantageous for the vendor to choose that offer so as to maximize long-term expected profit. The vendor might instead choose to maximize expected short-term profit on the transaction, making the offer that maximizes purchase probability times profit on the offer, but while this is optimal for single encounters, more typically the vendor hopes to sell many more items to the purchaser. In this case it is important both to maintain the shopper's perception that the transaction is fair and attractive, and to gather further information about the shopper's preferences which can be used to sell future items.

The profit on a sale is determined by two factors that vary from offer to offer: the profit per unit sold, and the quantity of units sold (0, 1, or possibly more). The former is mainly determined by the price, while the latter is affected by both price and advertisement.

The profit per unit sold is the unit benefit to the vendor minus the unit cost to the vendor. The unit cost of an product typically does not vary from offer to offer, but it can: for example, an offer that includes a service warranty costs the vendor extra. The unit benefit to the vendor if the shopper accepts an offer is typically just the price specified in the offer, but it too can vary in more interesting ways: for example, an offer that is about to expire, and so must be accepted immediately, has increased benefit per unit sold because payment for each such unit is immediate and shelf space is immediately freed. Similarly, an offer of a 10% discount carries greater benefit if the shopper must sign up for the store's credit card in order to be eligible. Of course, while the benefit per unit sold increases with such offers, the quantity sold might well drop. Finally, note that for all offers, but particularly for offers that are “novel” in the sense that the shopper has not previously accepted offers of this type of product from this vendor, the benefits to the vendor include possible brand loyalty from this shopper, and added information about the shopper's preferences, for this type of product. Because “novel” offers carry greater benefits to the vendor in this way, vendors may wish to reduce the price of such offers accordingly.

A simple approach is to try to maximize profit per shopper: e.g., for each product, make the highest-priced offer (price, advertisement and all) that the shopper is likely to accept. More generally, the idea is to maximize expected profit (i.e., the expected quantity sold multiplied by the unit profit) for that shopper or, more formally, to choose an offer j, for the given product that maximizes Σ_{I}Pᵢⱼqᵢnⱼ (we're maximizing over j, not summing)where qᵢ is a quantity that might be sold, nⱼ is the profit from selling one unit at the price specified by offer j, and pᵢⱼ is the probability of selling qᵢ units of offer j to the given shopper. Notice that it is necessary to estimate, for each offer j, the expected quantity Σpᵢⱼqᵢ (perhaps zero) that the shopper would buy. To make this estimation, we attempt to generalize to this (shopper, offer) pair from other, similarly profiled (shopper, offer) pairs, for which the actual quantities sold are known. For some offers, the shopper has a purchase limit, most commonly 1; the expected quantity should be between zero and this purchase limit. Finding the best offer requires taking two things into account—the expected sales from a <shopper, offer> pair, AND the profitability of the offer to the vendor. It is easy to sell lots of product—just sell it below cost but this is rarely a desirable strategy! The most straightforward way to address this problem is to group shoppers together to predict how likely each shopper is to purchase a given offer (which includes product, price and promotion), and then use a separate optimization method to determine which offers to make. In mathematical terms, profit=q(V,X) po (V,X)=quantity sold times profit, where profit, n, is a known function of the shopper, V, and offer, X, and the quantity sold, q, is a function which needs to be estimated. Once one has estimated q(V,X) by clustering similar shoppers and offers together (as described above) and using the expectation that similar shoppers will buy similar quantities of similar offers, then profit can be maximized directly by the obvious method of seeing what V and X make the profit largest.

Alternatively, one can work to directly maximize profit by clustering the shoppers by—and providing each cluster of shoppers with a cluster specific offer for each product, adjusting the offers for each cluster of shoppers over time (modifying the function X(V)) such that the profit within that cluster is increased. For example, the system might try incremental changes in the offering for some shoppers: e.g., varying the price up or down by a nickel, and floating the new offer to see whether it increases profits.

Often, more information is available about shoppers interest (e.g., what web pages were dialed on) than on what shoppers have purchased, thus it may be relatively easy to estimate expected interest (will the shopper click on the ad), but harder to estimate sales (e.g., if only one person in 30 user clicks actually buys).

Unfortunately, expected sales is not the same as expected interest. We need to be able to tell not only that offer X is more interesting than offer Y—a ranking—but how much more likely it is to be accepted (e.g., will the product sell 30% better on average with the promotion than without it?). In our preferred implementation, data are collected on what fraction of shoppers who express a given level of interest end up buying the product. For example, shoppers are grouped into interest quintiles (lowest 20% of interest, next highest 20% of interest, etc.), and statistics are kept of what fraction of each interest quintile end up buying the product.

An alternate method for automatically selecting and presenting a spectrum of different price values using a decision tree to split the price attribute for that particular shopper into multiple values for different though metrically similar items (starting with the more expensively tagged item) in order to ascertain the price/demand relationship more accurately for that associative attribute of particular relevance to that given shopper. In cases where the purchaser's loyalties are split between two or more brands (often similar) it is advantageous to use more compelling promotional incentives in order to induce the purchaser to decide in favor of a given product.

Shoppers who do most or all of their shopping off-line are characterized by having very incomplete profiles, limited relevance feedback, and little or no chance to participate in rapid profiling. Nonetheless, it is often possible to draw conclusions from the little that is known about them: one can find on-line shoppers with comparable (albeit richer) profiles, and rely on the more extensive relevance feedback of these on-line shoppers. The generalizations about on-line purchasing patterns can be used to market to off-line shoppers. For example, paper coupons can be mailed to the off-line shoppers, according to the price points determined for comparable on-line shoppers. Because it is easy to present many options to an on-line shopper, one can use the on-line shopping as an opportunity to research the interests and buying patterns of shoppers who are not on-line.

### Parameterized Offers

In general, an offer is an assemblage of many details—not only a product but also a price, a size, a price presentation, a sales pitch, an advertisement's visual style, and so forth, all of which are recorded as attributes in the offer profile. Thus there might be 72 different offers for a tube of Crest toothpaste. However, the shopper is only likely to accept at most one of these offers, so it is usually unnecessary for the shopping system to consider each of these offers independently for presentation to the shopper. A process of iterative refinement can be used. First, the shopping system determines whether the set of offers made to the shopper ought to include an offer of a tube of Crest toothpaste at all. If not, for example because the shopper has specified that she wants to buy a sofa bed, or because she is known to dislike toothpaste, then the system has eliminated all 72 offers at once. On the hand, if the system does decide to present an offer of a tube of Crest toothpaste, it must then choose the single best offer of that sort, by specifying the price, the size, and so forth. Thus, the 72 offers may be conveniently regarded as a single, parameterized, generic “tube of Crest toothpaste” offer that may be selected and then refined by specification of its parameters. It is useful to make some points about these parameters. First, they are essentially just attributes. Second, they need not be orthogonal: the offered prices for the small tube may differ from the offered prices for the large tube. Third, it may happen that some parameters used by the shopping system (e.g., choice of whether to use the “fights plaque” or the “cool minty breath” sales pitch) are peculiar to toothpaste, while others (size) apply somewhat more broadly to household supplies, and still others (price presentation) apply to a wide variety of offers. This last fact makes it tricky to decide how similar a tube of toothpaste is to a plunger, but the similarity measurement subsystem, described above, includes a “cross-genre” technique for computing the distance between offer profiles in such cases. There will often be too many potential parameterizations to keep statistics for each as a separate offer in a database. Efficient generalization over the relatively sparse data is key to successful implementation. The details of how this is done depends on the exact set of goods being sold. For some products a large number of parameters may be appropriate. For instance, a managed investment portfolio does not just have a name, a price, and a sales pitch. It may also have several other parameters that can be independently varied, such as the duration of a required holding period (illiquidity), the dividend reinvestment policy, and a stipulated upper limit on the percentage of holdings in any one sector (diversification). Other examples of highly parameterized products include insurance policies and cosmetic makeovers. When a vendor makes an offer to a shopper, not only the price and sales pitch but all the parameters may be selected so as to maximize the vendors expected long-term profit. For example, if the vendor is selling an insurance policy, it can offer a policy that is tailored to the particular shopper. The vendor can select such an offer using the same methods described above, which predict the shopper's receptivity to each offer by generalizing from similar shoppers and/or similar offers. Shoppers' demand for various car insurance policies might be predictable from the policies they have bought in the past, as well as the policies bought by others with similar income, family size, car age and value, driving habits, and questions. Instead of explicitly considering and selecting among all possible parameter settings, a vendor might instead use a specialized expert system to construct a set of viable versions of the parameterized offer. For example, an expert system for cosmetic makeovers might scan the shopper's profile for purchases of clothing, cosmetics, and hair care products, make inferences as to her general appearance, and then present one or more alluring “new you” pictures. As another example, an expert system might recommend a particular set of upgrades to a computer system, perhaps both by asking questions of management and by consulting system logs that document the demands placed on the existing system and the consequent performance. If the expert system constructs several or many versions of a parameterized offer, say at different prices, then similarity-based techniques may again be used to predict how receptive the shopper will be to each of these constructed offers. Although a vendor's initial sales pitch might specify only the best of the insurance policy or cosmetic makeover offers, or perhaps the best few offers (especially when none of the offers is clearly best), the vendor will typically be willing to make alternative versions of the offer available to the shopper. Thus, if the vendor's initial offer does not perfectly guess the shopper's preferred insurance deductible or shade of lipstick, the shopper might ask the vendor to suggest additional versions of the offer, possibly specifying certain desired parameters (e.g., that the insurance deductible should fall in a certain range). Recall that we can characterize a user not only by the responsiveness of the user to certain offers but also by many other attributes, including the loyalty and consistency factor. Example of such user profile attributes (largely numeric) include: elapsed time period since the last purchase, elapsed time period between purchases (average), ranges elapsed period to previous offers, total amount spent over the past 6 months, maximum volume spent on a single shopping spree. If a customer (particularly a long term customer) has recently been lost the system may find it advantageous to use the most aggressive promotional offers possible in order to reinitiate lost loyalties. Conversely, somewhat less aggressive discounting may be appropriate for very loyal customers (such as frequent buyer programs, long term customer rewards etc.). By the system these types of incentive based promotions are geared towards instilling customer interest and loyalty. Another relevant user attribute is time of the day, day of the week, etc. We can thus predict for example such correlations as movie entertainment or dinner foods may be popular during evening hours. These time dependent attributes may thus be viewed as separate user profiles through belonging to the same user. Occasionally such profiles may be activated on a time independent basis by the user in relevant engaging activities as in accordance with the particular mood the user happens to be presently experiencing.

### Joint Promotions

The same profiling approach described above can be used to select joint promotions. The basic method is to observe what items are bought by similar customers. For example, purchasers of beer at convenience stores are observed to also tend to purchase chips, pretzels and (less obviously) baby diapers. Such correlations can be noted from users' on-line purchase histories and used to generate joint promotions (“buy a new set of skis and get a free lift ticket at a ski resort”) known as data mining. Similarity may be used as a criteria for integrating two or more products into a single promotional offer. Because promotions, not products by themselves constitute a shopper's profile, a cross genre promotion involving a combination of two product promotions which are metrically close within that shopper profile. For example, suppose a shopper really goes for sales pitches that emphasize health benefits. Also, she really likes getting discounts, and she likes buying in large sizes. Then the system should try to find two large-size products that can be discounted and pitched as healthy, and bundle them together. For example, it might tell her that if she buys a family-size tube of plaque-fighting Crest at 10% off AND a set of three at 10% off, then she'll get an extra dollar off.

Fully automating the process of selected joint promotions is tricky. A key issue is specifying when two offers are suitable for a joint promotion, and how to set the discount and advertising for the promotion if this is done automatically. Clearly the two offers should be of interest to the same shoppers, even if they don't have much else in common. In addition, they should probably have product types that are different but not too different, and prices that are not too far apart. The trick is to find complementary goods, rather than competing goods or goods that appear to be bizarrely unrelated. “Buy this 1997 Chevrolet, no money down, and get this bottle of diet pills for $1 off!” (Note that one must be careful in the selection of promotions because being offered a joint promotion between Crest and Colgate toothpaste would probably not make sense!) It is useful to have some hand crafted rules to limited automatically discovered correlations. Such rules might include which products should not be discounted, how to distribute discounts between different products (“buy a floor mat for your new car and get $10 off the car” does not sound as good as “buy a car and get $10 off the floor mat for it”), etc.

Similarly, products can be customized using the same approach: components of an offer can be assembled into a package offer as was done when the different products were combined above. For example, one could construct a package deal on a customized set of computer components, select software features considering previously purchased features and the type of utilization of those features as well as build customized investment portfolios. Or creating a recommendation for a scheme which is can be retrofit to an existing set of parameters. Example applications include selecting the best apparel to match an existing piece (or pieces) of a shopper's existing wardrobe (considering also the shopper's basic appearance features); creating an ideal decor for a shopper's house based upon fixed parameters of its existing appearance; recommending an ideal architectural design based on the parameters of the shopper's wants and needs, and recommending the most “perfect” combination of food items (recipes and wines) which go with each other or are best added onto an existing combination in a gourmet meal. Another case in which this may be useful is the application towards the increasingly popular trend towards customize products e.g., certain design preferences could either be entered or a decision tree may acquire the shopper's interests or instead, the shopper's description or submission of examples of what he/she wants may be matched with the most metrically “similar” selections or selection features available based upon other previous descriptions in which the shoppers request was satisfied. In the case of running shoes a decision tree and/or expert system can quickly ascertain the shopper's needs based on functional performance parameters, however, the aesthetic features may be tailored by shopper request. Similarly, for bicycles, ski jackets, sweaters, etc. Due to the manufacturers' efficiency constraints, some of the features which are less popular or less cost efficient to include may be eliminated and/or the most popular combinations may be used as valuable information for use to predict the most popular standard designs (mass produced selections manufactured or sold at a standard lower price).

Note that the same selection of offers so as to maximize profit as was used in the above section on “automatically selecting offers to maximize vendor profit” applies to all of the above joint promotions. In accordance with the methods presently described, dynamically generated links between sites may present a joint promotion unique to the user and may combine different vendors and/or their products in different ways. It is thus extremely important for certain constraints to be mutually agreed upon and thus predetermined by the vendors which may be presented in a joint promotion. Such constraints could include: minimum thresholds for user traffic (as a protection for higher traffic vendors), non-competitive market niches, reasonably equivalent product quality or value. If a different (lower) traffic site wishes to be jointly promoted with a higher traffic site, it is useful to identify similar product/industry and automatically extrapolate and relative traffic volume exchanges a “market rate” for the present exchange as compensation to the higher traffic site. Similarly, for example the price or trade equivalent value of an ad on a news site can be automatically determined in order to fully automate an advertisement placement between the advertiser and the vendor. Alternatively, in accordance with the present techniques, the control of pricing by a given vendor, for each advertiser (customer can be automated using the presently described custom pricing scheme). Attributes pertaining to predicted click through which are of particular relevance include the relative traffic of the advertiser on other site (or other sites), time of the day (accounting temporal changes in the user's profile). The industry of the advertiser may be relevant and similar attributes relating to the vendor are useful to consider as well as the particular content on the advertiser's page at the time of the ad placement.

### Selection of Advertising

One way in which offers may be presented to a shopper is through advertising in an on-line medium that may or may not be primarily devoted to shopping. This application is not substantially different from the basic on-line shopping application. For the sake of concreteness, consider an on-line magazine that, whenever it displays an article to a reader, also displays an advertisement selected automatically from its database of possible advertisements. We may regard the magazine as a vendor, each reader as a shopper, the database of possible advertisements as an offer database, and each advertisement as an offer wherein the shopper, if he or she accepts, agrees to learn more about the advertiser (for example, by clicking on the advertisement) or purchase a product from the advertiser. The magazine is paid a pre-arranged amount by the appropriate advertiser whenever a shopper accepts an offer. It is in the magazine's interest to maximize its profit by exactly the same methods for other vendors, as taught above: roughly, by displaying to each reader the most profitable advertisements that particular reader is likely to succumb to.

### Shopper Browsing of Offers

The on-line shopping system can optionally give the shopper the ability to browse through a plurality of offers, which offers constitutes a subset of the offers described in the offer database. The offers available for browsing will not typically include all the offers in the database, in that only one price and one advertising presentation will be available for each product. However, all products may be available, each with a price and presentation that are chosen for the particular shopper. In the preferred embodiment, the shopping system makes at least one version of each parameterized offer available, choosing the version or versions that will maximize vendor profit as before. Because this still means that a great many offers are available to the shopper, the shopping system provides assistance to the shopper in browsing through those offers. A hierarchical cluster tree imposes a useful organization on the collection of offers available for browsing by a shopper. The tree may be constructed as described earlier in this description, and is of direct use to a shopper who wishes to browse through all the offers in the tree. Such a shopper may be exploring the collection with or without a well-specified goal. The tree's division of offers into coherent clusters provides an efficient method whereby the shopper can locate an offer of interest. The shopper first chooses one of the highest level (largest) clusters from a menu, and is presented with a menu listing the subclusters of said cluster, whereupon the shopper may select one of these subclusters. The system locates the subcluster, via the appropriate pointer that was stored with the larger cluster, and allows the shopper to select one of its subclusters from another menu. This process is repeated until the shopper comes to a leaf of the tree, which yields the details of an actual offer. Hierarchical trees allow rapid selection of one offer from a large set. In ten menu selections from menus of ten items (subclusters) each, one can reach 10¹⁰=10,000,000,000 (ten billion) items. In the preferred embodiment, the shopper views the menus on the screen of the shopper's local terminal, and selects from them with a keyboard or mouse. However, the shopper may also make selections over the telephone, with a voice synthesizer reading the menus and the shopper selecting subclusters via the telephone's touch tone keypad. In another variation, the shopper simultaneously maintains two connections to the server, a telephone voice connection and a fax connection; the server sends successive menus to the shopper by fax, while the shopper selects choices via the telephone's touch tone keypad.

Since a shopper who is navigating the cluster tree is repeatedly expected to select one of several subclusters from a menu, these subclusters must be usefully labeled, in such a way as to suggest their content to the human shopper. It is straighfforward to include some basic information about each subcluster in its label, such as the number of offers the subcluster contains (possibly just 1) and the number of these that have been added or updated recently. However, it is also necessary to display additional information that indicates the cluster's content. This content descriptive information may be provided by a human, particularly for large or frequently accessed clusters, but it may also be generated automatically. As an example, consider the domain where each offer is an offer to view a pay-per-view movie. The basic automatic technique is simply to display a cluster's “characteristic value” for each of a few highly weighted attributes. With numeric attributes, this may be taken to mean the cluster's average value for that attribute: thus, if the “year of release” attribute is highly weighted in predicting which movies a given shopper will like, that is, it has a large attribute weight or a quality attribute weight of large absolute value, then it is useful to display average year of release as part of each cluster's label. Thus the shopper sees that one cluster consists of movies that were released around 1962, while another consists of movies from around 1982. For short textual attributes, such as “title of movie” or “title of document,” the system can display the attribute's value for the cluster member (offer) whose profile is most similar to the cluster's profile (the mean profile for all members of the cluster), for example, the title of the most typical movie in the cluster. For longer textual attributes, a useful technique is to select those terms for which the amount by which the term's average term score across members of the cluster exceeds the term's average term score across all offers is greatest, either in absolute terms or else as a fraction of the standard deviation of the term's term score across all offers. The selected terms are replaced with their morphological stems, eliminating duplicates (so that if both “slept” and “sleeping” were selected, they would be replaced by the single term “sleep”) and optionally eliminating close synonyms or collocates (so that if both “nurse” and “medical” were selected, they might both be replaced by a single term such as “nurse,” “medical,” “medicine,” or “hospital”). The resulting set of terms is displayed as part of the label. Finally, if thumbnail photographs or other graphical images are associated with some of the offers in the cluster for labeling or advertisement purposes, then the system can display as part of the label the image or images whose associated offers have offer profiles most similar to the cluster profile.

Shoppers' navigational patterns may provide some useful feedback as to the appropriateness of the labels. In particular, if shoppers often select a particular cluster to explore, but then quickly backtrack and try a different cluster, this may signal that the first cluster's label is misleading. Insofar as other terms and attributes can provide “next best” alternative labels for the first cluster, such “next best” labels can be automatically substituted for the misleading label. In addition, any shopper can locally relabel a cluster for his or her own convenience. Although a cluster label provided by a shopper is in general visible only to that shopper, it is possible to make global use of these labels via a “shopper labels” textual attribute for offers, which attribute is defined for a given offer to be the concatenation of all labels provided by any shopper for any cluster containing that offer. This attribute influences similarity judgments: for example, it may induce the system to regard offers in a cluster often labeled “Sports Gear” by shoppers as being mildly similar to offers in an otherwise dissimilar cluster often labeled “Sports News” by shoppers, precisely because the “shopper labels” attribute in each cluster profile is strongly associated with the term “Sports.” The “shopper label” attribute is also used in the automatic generation of labels, just as other textual attributes are, so that if the shopper generated labels for a cluster often include “Sports,” the term “Sports” may be included in the automatically generated label as well.

It is not necessary for menus to be displayed as simple lists of labeled options; it is possible to display or print a menu in a form that shows in more detail the relation of the different menu options to each other. Thus, in a variation, the menu options are visually laid out in two dimensions or in a perspective drawing of three dimensions. Each option is displayed or printed as a textual or graphical label. The physical coordinates at which the options are displayed or printed are generated by the following sequence of steps: (1) construct for each option the cluster profile of the cluster it represents, (2) construct from each cluster profile its decomposition into a numeric vector, as described above, (3) apply singular value decomposition (SVD) to determine the set of two or three orthogonal linear axes along which these numeric vectors are most greatly differentiated, and (4) take the coordinates of each option to be the projected coordinates of that option's numeric vector along said axes. In this way, related products are displayed near each other; the display may use graphics so that similar products appear to sit on the same “shelf.” For this purpose, it is useful for offer profiles to include an associative attribute indicating which other items are often bought on the same shopping “trip” as this item; items that are often bought on the same trip will be judged similar with respect to this attribute, so tend to be grouped together. Step (3) may be varied to determine a set of, say, 6 axes, so that step (4) lays out the options in a 6 dimensional space; in this case the shopper may view the geometric projection of the 6 dimensional layout onto any plane passing through the origin, and may rotate this viewing plane in order to see differing configurations of the options, which emphasize similarity with respect to differing attributes in the profiles of the associated clusters. In the visual representation, the sizes of the cluster labels can be varied according to the number of offers contained in the corresponding clusters. In a further variation, all options from the parent menu are displayed in some number of dimensions, as just described, but with the option corresponding to the current menu replaced by a more prominent subdisplay of the options on the current menu; optionally, the scale of this composite display may be gradually increased over time, thereby increasing the area of the screen devoted to showing the options on the current menu, and giving the visual impression that the shopper is regarding the parent cluster and “zooming in” on the current cluster and its subclusters.

The technology described earlier for determining shoppers' interest in offers can also aid a shopper in navigating among the offers. Although the topology of a hierarchical cluster tree is fixed by the techniques that build the tree, the hierarchical menu presented to the shopper for the shopper's navigation need not be exactly isomorphic to the cluster tree. The menu is typically a somewhat modified version of the cluster tree, reorganized manually or automatically so that the clusters most interesting to a shopper are easily accessible by the shopper. In order to automatically reorganize the menu in a shopper specific way, the system first attempts automatically to identify existing clusters that are of interest to the shopper. The system may identify a cluster as interesting because the shopper often accesses offers in that cluster—or, in a more sophisticated variation, because the shopper is predicted to have high interest in the cluster's cluster profile, using the methods disclosed herein for estimating interest from relevance feedback.

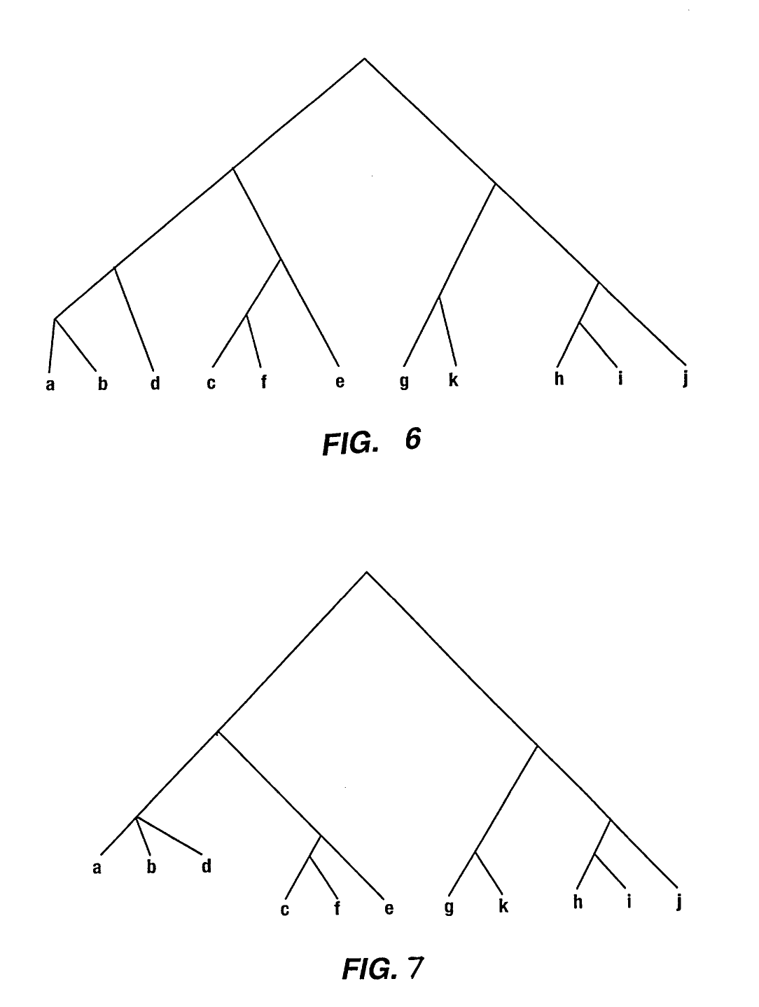

Several techniques can then be used to make interesting clusters more easily accessible, in order to aid the shopper's task. The system can at the shopper's request or at all times display a special list of the most interesting clusters, or the most interesting subclusters of the current cluster, so that the shopper can select one of these clusters based on its label and jump directly to it. In general, when the system constructs a list of interesting clusters in this way, the ith most prominent choice on the list, which choice is denoted Top(l), is found by considering all appropriate clusters C that are further than a threshold distance t from all of Top(1), Top(2), . . . Top(l 1), and selecting the one in which the shopper's interest is estimated to be highest. Here the threshold distance t is optionally dependent on the computed cluster variance or cluster diameter of the profiles in the latter cluster. Several techniques that reorganize the hierarchical menu tree are also useful. First, menus can be reorganized so that the most interesting subcluster choices appear earliest on the menu, or are visually marked as interesting; for example, their labels are displayed in a special color or type face, or are displayed together with a number or graphical image indicating the likely level of interest. Second, interesting clusters can be moved to menus higher in the tree, i.e., closer to the root of the tree, so that they are easier to access if the shopper starts browsing at the root of the tree. Third, uninteresting clusters can be moved to menus lower in the tree, to make room for interesting clusters that are being moved higher. Fourth, clusters with an especially low interest score (representing active dislike) can simply be suppressed from the menus; thus, a shopper with children may assign an extremely negative quality attribute weight to the “vulgarity” attribute, so that vulgar clusters and documents will not be available at all. As the interesting clusters and the documents in them migrate toward the top of the tree, a customized tree develops that can be more efficiently navigated by the particular shopper. If menus are chosen so that each menu item is chosen with approximately equal probability, then the expected number of choices the shopper has to make is minimized. If, for example, a shopper frequently accessed offers whose profiles resembled the cluster profile of cluster (a, b, d) in FIG. 2 then the menu tree in FIG. 6 could be modified to show the structure illustrated in FIG. 7 (the menu tree is to be interpreted that users are presented either cluster labels (for junctions) or leaf values selecting a cluster level that moves the user down the tree towards the leaves).

Another offer selection technique complements the menu tree approach. When the system presents the shopper with a menu of subclusters of a cluster C of offers, it can simultaneously present an additional menu of the most interesting offers in cluster C, so that the shopper has the choice of accessing a subcluster or directly accessing one of the offers. If this additional menu lists n offers, then for each I between 1 and n inclusive, in increasing order, the ith most prominent choice on this additional menu, which choice is denoted Top(C,i), is found by considering all offers in cluster C that are further than a threshold distance t from all of Top(C,1), Top(C,2), . . . Top(C, I 1), and selecting the one in which the shopper's interest is estimated to be highest. If the threshold distance t is 0, then the menu resulting from this procedure simply displays the n most interesting offers in cluster C, but the threshold distance may be increased to achieve more variety in the offers displayed. Generally the threshold distance t is chosen to be an affine function or other function of the cluster variance or cluster diameter of the cluster C. As a novelty feature, the shopper U can “masquerade” as another shopper V, such as a prominent intellectual or a celebrity supermodel; as long as shopper U is masquerading as shopper V, the offer selection technology will still select the offers that would ordinarily be available to shopper U, but the interest determination technology will judge offers more or less interesting not according to shopper U's profile and offer demand summary (herein termed “shopper U's shopper-specific data”), but rather according to shopper Vs shopper-specific data. In a variation, this technique is employed not with the shopper-specific data of a celebrity shopper V, but rather with the mean of the shopper-specific data of shoppers in a selected demographic group; thus, shopper U can masquerade as the average member of group G, as is useful in exploring group preferences for sociological, political, or market research. More generally, shopper U may “partially masquerade” as having some other shopper-specific data S, meaning that the interest determination technology judges offers more or less interesting not according to shopper U's shopper-specific data, but rather according to a weighted average of shopper U's shopper-specific data and the data S. In the variation where the general techniques disclosed herein for estimating a shopper's interest from relevance feedback are used to identify interesting clusters, it is possible for a shopper U to supply “temporary relevance feedback” to indicate a temporary interest that is added to his or her usual interests. (This technique is separate from the related technique, discussed earlier, wherein the shopper's profile includes “short-term” attributes that characterize the shopper's temporary shopping goals and emotional state.) The shopper can supply such “temporary relevance feedback” by specifying a search profile or “query”, i.e., an offer profile such that the shopper U is interested in offers with similar profiles. This query becomes “active,” and affects the system's determination of interest in either of two ways. In one approach, an active query is treated as if it were any other offer, and by virtue of being a query, it is taken to have received relevance feedback that indicates especially high interest. In an alternative approach, offers X whose offer profiles are similar to an active search profile are simply considered to have higher quality q(U, X), in that q(U, X) is incremented by a term that increases with offer X's similarity to the query profile. Either strategy affects the usual interest estimates: clusters that match shopper U's usual interests (and have high quality q(*)) are still considered to be of interest, and clusters whose profiles are similar to an active query are adjudged to have especially high interest. Clusters that are similar to both the query and the shopper's usual interests are most interesting of all. The shopper may modify or deactivate an active query at any time while browsing. In addition, if the shopper discovers an offer or cluster X of particular interest while browsing, he or she may replace or augment the original (perhaps vague) query profile with the offer profile of offer or cluster X, thereby amplifying or refining the original query to indicate an particular interest in offers similar to X. For example, suppose the shopper is browsing through documents, and specifies an initial query containing the word “Lloyd's,” so that the system predicts documents containing the word “Lloyd's” to be more interesting and makes them more easily accessible, even to the point of listing such documents or clusters of such documents, as described above. In particular, certain articles about insurance containing the phrase “Lloyd's of London” are made more easily accessible, as are certain pieces of Welsh fiction containing phrases like “Lloyd's father.” The shopper browses while this query is active, and hits upon a useful article describing the relation of Lloyd's of London to other British insurance houses; by replacing or augmenting the query with the full text of this article, the shopper can turn the attention of the system to other documents that resemble this article, such as documents about British insurance houses, rather than Welsh folk tales.

In a system where queries are used, it is useful to include in the offer profiles an associative attribute that records the associations between an offer and whatever terms are employed in queries used to find that offer. The association score of offer X with a particular query term T is defined to be the mean relevance feedback on offer X, averaged over just those accesses of offer X that were made while a query containing term T was active, multiplied by the negated logarithm of term T's global frequency in all queries. The effect of this associative attribute is to increase the measured similarity of two documents if they are good responses to queries that contain the same terms. A further maneuver can be used to improve the accuracy of responses to a query: in the summation used to determine the quality q(U, X) of an offer X, a term is included that is proportional to the sum of association scores between offer X and each term in the active query, if any, so that offers that are closely associated with terms in an active query are determined to have higher quality and therefore higher interest for the shopper. To complement the system's automatic reorganization of the hierarchical cluster tree, the shopper can be given the ability to reorganize the tree manually, as he or she sees fit. Any changes are optionally saved on the shopper's local storage device so that they will affect the presentation of the tree in future sessions. For example, the shopper can choose to move or copy menu options to other menus, so that useful clusters can thereafter be chosen directly from the root menu of the tree or from other easily accessed or topically appropriate menus. In an other example, the shopper can select clusters C₁, C₂ . . . Cₖ listed on a particular menu M and choose to remove these clusters from the menu, replacing them on the menu with a single aggregate cluster M′ containing all the offers from clusters C₁, C₂ . . . Cₖ . In this case, the immediate subclusters of new cluster M' are either taken to be clusters C₁, C₂ . . . Cₖ themselves, or else, in a variation similar to the “scatter gather” method, are automatically computed by clustering the set of all the subclusters of clusters C₁, C₂ . . . Cₖ according to the similarity of the cluster profiles of these subclusters. It should be appreciated that a hierarchical cluster tree may be created, as noted earlier, with “soft clustering” rather than “hard clustering.” In this case, a given cluster of offers (or individual offer) may appear as a subcluster of more than one larger cluster. That is, each cluster at a given level n, where clusters at level 0 are simply individual offers, has some degree of membership (between 0 and 1) as a subcluster in each cluster at level n+1. The menu for a cluster C at level n+1 may in principle list as subclusters all clusters at level n, listed in order of decreasing membership in cluster C. Usually, however, it is desirable to include only some of these subclusters in the menu for cluster C, such as all clusters at level n whose degree of membership in cluster C is greater than a certain threshold. Various procedures are available to assign clusters at level n to the subcluster menus for clusters of level n+1, but in general it is useful to impose the restriction on such procedures that every cluster at level n+1 should list from 2 to 7 subclusters, and that every cluster at level n should appear on from 1 to 4 menus, or some similar restriction. In another variation, the shopper is able to perform lateral navigation between clusters at level n as well as choosing them from the menus of clusters at level n+1, by requesting that the system search for a cluster whose cluster profile resembles the cluster profile of the currently selected cluster. The effect is one of a “virtual mall” in which related departments are linked.

Merchants might pay for better shelf space in electronic shopping malls, just as they pay advertising. They already do this in off-line bookstores and supermarkets. The value of “shelf space” may be appraised automatically by cross correlating the purchasing response of similar shoppers to an identical item located in different shelf locations through out the virtual store. (I.e., different shoppers would see different shopping mall layouts, and the relative purchase rates from the different layouts would be compared.) This three dimensional spatial representation may further be extended to include different genres of virtual stops available on the Internet. For example a virtual book store, virtual library, virtual shops of varying sub genres such as music, travel agency, automobile dealership. As in the electronic shopping mall, this virtual village representation is designed in a two or three level hierarchical tree structure wherein each node is a graphical representation of what is contained therein e.g., a music store, category/genre and album title or alternatively “similar” store fronts may be aggregated into a single graphic icon i.e., a single graphic of a music store which provides access to a virtual mall of selections. Each dominant cluster (icon or popular purchase selection) may further contain an associated virtual club of shoppers whose profiles are the most “similar” to that cluster or selection e.g., including the most knowledgeable individuals, an active BBS with archives), chat room. Thus it is possible to represent the entire navigable search space of the World Wide Web (e.g., as a search engine adaptation) as a two or three dimensional space i.e., with a walk through virtual village as the first level in the hierarchy and these spaces within each of the respective stores (or other buildings) as the next level down.

### Use of Profiles for Off-line Sales

Collecting data about consumers during their on-line shopping offers several advantages for market research over currently available data for off-line shopping. First, the identities of on-line shoppers are almost always known, unlike in many off-line shopping locations. It is much easier to change the price and promotion of items sold on-line and even the layout of products in a virtual shopping mall than it is for objects with physical price tags on physical shelves. Detailed data is available tracking the user's “click-stream”: exactly how much time was spent looking at each page of information and what order they were looked at in. The data collected on-line can then be used to improve sales to off-line shoppers noting what prices, promotions and layouts work well in general or for specific demographic groups. As more the identities of more off-line shoppers becomes known (e.g. through them using credit cards or store membership cards), off-line shopping will become less distinguishable from on-line shopping.

### Recommendation and Coupon System Using Point of Sale Devices

The methods described above for maximizing profit by selecting promotions using groupings of shoppers based on the history of their purchases and their responses to promotions is ideally suited for use in stores with point-of-sale (POS) scanning devices. Shoppers are issued identity cards or other ID devices so that when they make purchases, record can be kept at what each shopper has purchased. These records are then used to generate promotions, including price discounts (e.g., by coupons), advertisements (e.g., recipes using featured food products), or information (e.g., a suggested shopping list). Typically some combination of these will be used.

The preferred architecture is a variation of that presented in FIG. 1. Purchase data are collected from POS devices 131-13n and stored on main computer. The offer match computer 113 assigns offers to customers, using the techniques described above. Offers may be preassigned, using batch processing techniques, or they can be dynamically assigned as the shopper is presently active within the venue of the system. If the offers are preassigned, they are stored in the shopper database 121.

More formally, the steps in this process are as follows:

1. Shopper identifies themself to the system at one of the local terminals 131-13n via a smart card, magnetic tape card, radio frequency ID for wireless systems, or other ID (e.g., retinal scan, voice recognition, etc.).

2. The system for the automatic determination of customized prices and promotions 100 determines which promotions to offer to this customer, using techniques described above. The offers can be pre-assigned and stored in the shopper database 121 or dynamically assigned by the offer match processing computer 113.

3. Promotions are presented to the shopper. Coupons may be printed, or screens drawn on a kiosk or portable computer, the promotions offered are recorded. Alternatively, the offers can be predicated on a related purchase. Thus, when the shopper purchases item A, the system for the automatic determination of customized prices and promotions 100 offers a coupon on related item B.

4. When the shopper requests further information (e.g., at a kiosk) or purchases items, the records for that shopper are updated. In all cases, the offers presented to the shopper are recorded in the shopper database 121 as well as shopper queries.

For shoppers for whom no purchase history is available, promotions may be generated by using a “typical” purchase history.

### Making Custom Recommended Promotions to Customers via Human

### Intermediaries (Sales Agents)

In one embodiment of the presently disclosed technique, it is a human intermediary (“salesperson”) who offers a product to a potential customer (“shopper”) on behalf of the vendor. The techniques can be used by a vendor as before to select the most appropriate products, prices, promotions, and sales pitches—that is, the most appropriate offers—for a salesperson to present to a given shopper. They may also be used to select a salesperson who is likely to be successful in making such a presentation, as well as shoppers who are likely to buy a given product. We continue to use the term “shopper” to refer to consumers, even if they are not actively shopping but rather are being approached by salespersons. The methods used for this embodiment do not differ in most respects from those disclosed above. However, the attributes chosen to constitute shopper profiles and offer profiles in this embodiment will typically reflect the use of human intermediaries. Another distinguishing feature of this embodiment is that it is the salesperson, rather than an on-line shopping system, who is typically responsible for presenting the offer to a shopper, completing the sale if possible, and updating the shoppers profile.

### Profiles for Sales Force Automation

In high-end sales automation systems that are commercially available at present, salespersons maintain detailed records of each sales call made. To apply our technique, each sales call is treated as a separate offer (so that multiple calls to the same shopper correspond to distinct offers), and the record of the sales call is treated as an offer profile. For additional detail, a long sales call may be treated as a series of offers, corresponding to different products that are discussed during the call, or a series of sales pitches attempted for a single product.

Attributes used in an offer profile typically include those exemplary attributes of offer profiles discussed earlier in this disclosure (describing the product, price, promotion, sales pitch, and shoppers who have previously shown interest in offers with these attributes), as well as additional attributes including but not limited to the identity, prior experience and demographic properties of the salesperson, the weekday and time of day of the sales call, the number of previous calls made to this shopper, the time elapsed since the last such call, the duration of the call prior to the making of this offer, a Boolean flag indicating whether the salesperson for this call has previously spoken to the shopper, and so forth.

Notice that offers with certain profiles may be unavailable in a given situation. For example, if two calls have been previously made to a given shopper, then only offer profiles reflecting this fact should be evaluated by the apparatus as prospective profiles for the next offer to that shopper. Similarly, a given salesperson can only make offers whose profiles name him as the salesperson.

Attributes used in an shopper profile typically include those exemplary attributes of shopper profiles discussed earlier in this disclosure, as well as additional textual and/or numeric attributes that may be entered or modified by a salesperson during a sales call with the shopper. Such attributes might include previously unknown demographic or psychographic attributes noted by a salesperson (for example, a code for “short attention span” or a set of descriptive terms such as “hostile,” “chatty,” and “haggler”), a textual description (written by the salesperson) of the shopper's response to a particular sales pitch, and perhaps even a rough transcript of the most recent dialogue between a salesperson and this shopper, as produced manually by the salesperson or automatically by a speech recognition system. If a shopper profile is incomplete, then rapid profiling techniques as discussed above can be used to determine the most important missing attributes, which the salesperson can attempt to elicit from the shopper.

### Dynamic Recommendations

An important feature of the sales force automation domain is that shopper profiles may change during the course of a sales call. For example, if a salesperson's first offer during the call is rebuffed, this fact contributes to the system's knowledge about the shopper. In particular, it may be immediately recorded in the shopper's profile, specifically in the list of offers that the shopper is known to like or dislike. Similarly, verbal remarks by the shopper may be added to the shopper's profile during the course of a sales call. These changes to the profile may affect the system's recommendation as to the salesperson's next action that is, how the salesperson should continue or terminate the call.

More precisely, dynamic changes to a shopper profile may affect the system's prediction as to which <shopper, offer> pair the salesperson can most profitably pursue next. For example, the system may predict that the best <shopper, offer> pair involves continuing the sales call to this shopper, but using a new sales pitch or offering a new product. Alternatively, the best pair might involve placing a call to a new shopper, or placing a follow-up call to a shopper who has previously spoken with the salesperson; in these cases the salesperson should terminate the current call and proceed with the recommended call. In some circumstances, such as marketing situations where a sales call is paid in person, it may be inconvenient to record changes to a shopper's profile during the course of a sales call. It is still possible, however, to use the system in advance of a sales call to plan a series of offers for the salesperson to present. First the system is used to choose the most promising offer, offer A. The shopper's profile is then temporarily modified to reflect the scenario where offer A is rejected, and the system is now used again to choose the most promising offer for this new situation, offer B, which may involve a different product, or perhaps a new price or sales pitch for the same product. In the same way, the shopper's profile is also temporarily modified to reflect other scenarios, such as the scenario where offer A is accepted, or reluctantly rejected as too expensive, and the system is again used to choose the most promising next offer, offer B′. This advance use of the system prepares the salesperson with an initial offer to make (offer A), and subsequent offers to make (offers B and B′) depending on the customer's reaction to the initial offer. This process constitutes an exploration of hypotheticals. It may continue for multiple steps, so that, for example, the plan produced by the system immediately in advance of the sales call suggests that the salesperson will be best off to terminate the call if offers A, B, and C have been rejected in sequence.

### Implementation

Because salespersons must work with offer profiles and shopper profiles under time-critical situations, when implementing this technology it is important to pay careful attention to the user interface. As an additional aid in the dynamic agent-mediated sales system, the user interface may be adapted to incorporate visualization tools for the sales person. Data mining will allow the sales person to identify certain correlations between the present user (and/or his/her unique attributes including domain specific price sensitivity), product/offer affinities, optimal sales pitches (or supplemental materials used in facilitating the sales process), probable statistically predicted next responses of the customer in response to each offer and/or sales pitch, likely additional attributes (e.g. psychographic) which can be inferred about the user based on feedback from the other attribute sources.

### Sharing Sales Force Automation Data among Vendors

Sales force automation tools are presently used in a variety of commercial domains and by many different vendors. Accordingly, it is appropriate to consider the mutual benefits which could be provided by cooperation or sale of information among vendors. Just as for other price-point determination systems, vendors may share information about particular shoppers, thereby enhancing each others' databases of shopper profiles. Also, just as in other price-point determination systems, vendors may share their databases of relevance feedback on <shopper, offer> pairs. Thus, when the system is evaluating a proposed <shopper, offer> pair to decide whether it is worth making a particular offer to a particular shopper, it has a better chance of finding similar <shopper, offer> pairs by consulting the several vendors' databases. For this kind of sharing to work, it is necessary to define a similarity metric that allows any two shopper profiles to be compared, even if the profiles are created and maintained by different vendors. It is also necessary to define such a metric for offer profiles used by different vendors. Finally, the relevance feedback used by different vendors must be comparable; for example, if one vendor rates <shopper, offer> pairs using active feedback on a 0-10 scale, and another rates them using passive feedback on a 0-255 scale, then some normalization of the feedback scores is needed before the databases are combined.

### Digital Coupons

It is often desirable for a vendor to charge different prices to different customers. (The prices charged may be selected using our price point determination system or by other means.) A standard approach is to advertise a high list price, but to furnish discount coupons to selected customers. When a computer network is available, it is efficient and inexpensive to use the network to provide selected customers with electronic analogues to such discount coupons. Specifically, a digital message called a “digital coupon” is transmitted to a customer over the computer network. The customer may later use his knowledge of the message contents to obtain a discount in an electronic or non-electronic transaction.

Precautions must be taken against forgery, alteration, reuse, or transfer of such coupons. (For this reason, a digital coupon should not simply consist of a textual message such as “The bearer of this message is entitled to a $5 discount on one packet of Koala brand playing cards.”) We present a method which uses standard encryption techniques to prevent such acts.

Our digital coupon system consists of two components: One for issuing the coupons and one for redeeming coupons. A coupon is issued by being transmitted electronically to a particular customer. A coupon consists of a two-part message, typically created specially for the customer to whom it is issued. Each of the two parts separately describes the benefits and obligations accruing to use of the coupon, and the terms under which the coupon may be used. The first part consists of natural language text that is intended for the customer to read when the coupon is issued. The second part consists of machine˜readable data intended for the vendor to read when the coupon is redeemed. As an example, which is not meant to be limiting, the second part of a coupon might specify the following information:

1. a unique identifier for the coupon (to prevent reuse)

2. an identifying code for the item being discounted

3. an expiration date

4. an identifier or public cryptographic key of the person who may use the coupon (to prevent transferability)

5. the dollar amount of the discount

Notice that if the second part of the coupon includes a unique identifier for the coupon, then no other fields need be present, since the vendor may use this unique identifier to retrieve the remaining fields (such as expiration date) from a stored database accessible to the vendor (or electronic proxy for the vendor). On the other hand, storing the remaining fields directly in the coupon, as in the above example, enlarges the coupon but relieves the vendor of the need to maintain such a database. If such additional fields are included in the second part of the coupon, then the second part of the coupon should be digitally signed by the vendor, to guard against alteration. Any standard method for digital signatures (such as an MD5 hash) may be used; alternatively, since in the digital coupon application only the signer (i.e., the vendor) will need to verify the signature, it is also possible to implement this signature as direct encryption via a key privately held by the vendor, using a standard encryption technique such as DES or PGP.

To redeem the coupon when carrying out an electronic or non-electronic transaction, the customer presents the vendor with the information from (at least) the second part of the coupon. In an embodiment where the second part of a coupon is digitally signed by the vendor, the vendor attempts to verify the integrity of such signature, and rejects the transaction and halts if such verification fails. Next, from this information, the vendor determines the benefits, obligations, and terms of use of the coupon, using a stored database if appropriate. The vendor then ensures that the terms of use specified by the information apply to the particular transaction. In the example above, this means checking (1) that the vendor has not previously redeemed any coupon with the same identifier; (2) that the item being purchased in the transaction is the item named by the coupon; (3) that the transaction date precedes the expiration date; and (4) that the customer making the transaction is the one identified in the coupon. In utilizing the presently described techniques, in order to automatically determine an optimal wager to present to the user, the risk to return ratio (treated as an attribute pair), the frequency of the user's visits to the casino, the average amount spent on a visit and perhaps the largest amount ever spent on a visit as well as the nature of the outcome of and how the user has responded (by his/her subsequent wager) to the previous wager. For maximum security, the vendor could verify the customers identity in (4) by biometric means, or by requiring the customer to present a password or personal smartcard, or via a cryptographic challenge whereby, for example, the customer uses his private key to encrypt a random string R chosen by the vendor, and the vendor verifies that R may be retrieved by decrypting this with the public key of the customer identified in the coupon. Many other methods are also available to verify the customers identity, for example, if the customer has sent the coupon to the vendor by an electronic mail message, then in most cases the vendor may determine the customer's electronic mail address by consulting the message header.

If all the terms of use apply when a coupon is presented for redemption, then the vendor carries out the transaction according to the stated terms of the coupon, for example by providing a discounted price. Finally, the vendor records in a database that the coupon having this unique identifier has now been used and may not be reused. In some commercial situations, obvious variants of this system may be desirable in which some of the restrictions are relaxed. For example, it may be desirable to allow transferability or reuse of coupons. The fewer the controls, the less storage and computation is required.

### Variations

Various means are available for storing the coupon information in a form that permits the shopper to redeem the coupon at a later time. These different types of storage have different costs and benefits, in particular for situations where the user may have no access to a computer communications network, or access only in certain circumstances. In one such variation, the coupon is stored on a portable “smart card” carried by the shopper, having been initially recorded on the card by a device attached to (for example) a computer controlled by the shopper or a kiosk or cash register controlled by the vendor or a third party. The coupon may then be redeemed at locations where a smart card reader is available. In another variation that is particularly useful when coupons are to be redeemed during on-line shopping, the coupon is stored on storage media attached to a computer terminal owned or controlled by the shopper, having been transmitted to said computer via electronic mail, a World Wide Web page, or another network service. In another variation, the coupon information is physically printed as a bar code or Optical Character Recognition code that can be interpreted by an suitable scanning device at a location where the shopper wishes to redeem the coupon; in this variation, coupons may be printed either by a shopper who has retrieved the coupon information over a network, or by the vendor, who can print and distribute such coupons either one at a time (for example, issuing a customized coupon to a shopper who is checking out of the vendor's store) or in large numbers (for example, when distributing customized coupons by direct mail or insertion into magazines). In another variation, the second part of the coupon consists only of a unique identifier for the coupon, as discussed above, which the user can memorize or record by any convenient means; such an identifier can be transmitted to the user in any convenient way, for example by reading it over a telephone or displaying it on a screen, and the user can redeem the coupon by providing this identifier to the vendor through on-line or off-line means.

### Shoppers' Agents and Filters

Similar profiling techniques can be built (e.g. into Internet browsers) which attempt to maximize consumer surplus, rather than the profitability of the vendor. Such consumer agents would be used to locate bargains—where “bargain” is defined from the standpoint of the individual shopper. I.e., given a profile of the shopper, combined with specific attributes of what the shopper is looking for, the consumer agent would search over one or more vendor sites to find items which are particularly appealing. Consumers may also wish to form buyers' clubs to strengthen their negotiating position with vendors, as described below. These consumers agents use the same profiling techniques described above: given past purchases of a shopper and, optionally, or shoppers with similar profiles, the consumers agent can estimate how much a shopper would be willing to pay for a given offer. If the price of the offer is significantly below the price the shopper is estimated to be willing to pay, then the item is a “bargain” for that shopper. The actual implementation could either take the above form: estimating price as a function of the offer (X) and the shopper (V), or estimating the probability of purchase as a function of the offer and the shopper, and selecting offers with a very high probability of purchase. Such consumer agents could, of course, also be offered by vendors, but with some risk for the shopper that the vendor would not choose to maximize the consumer surplus—i.e., might not find the best bargains for the shopper. In a typical application, the shopper's agent (software with access to both the user's profile and a multiplicity of offers available over the Internet) would examine enormous numbers of offers and select those which the shopper is most likely to purchase. These might include standard repeat purchases (staple items such as food and wine), items where each item is similar but still unique (compact disks and books), and items that are purely novel, but have been purchased by other shoppers with similar tastes

### Buyers' Clubs

The same profiling and clustering techniques described above can also be used more generally to match shoppers with vendors or other shoppers who have complementary interests. There are many situations in commerce where it is useful to match up multiple people with similar interests: shoppers can be matched to buy and sell items, to barter and exchange items, to wager with each other about sporting events, to place bids on an item(s) being auctioned to hedge risk, to get lower prices by purchasing in bulk, or to discuss their common interests. A group of shoppers with similar shopper profiles or offer demand summaries can be thought of as a buyers' club or a ‘mini’-market that is assembled automatically, on an ad hoc basis.

The buyers' club subsystem attempts to identify groups of shoppers with common interests. These groups, herein termed “pre-clubs,” are represented as sets of shoppers. Whenever the buyers' club subsystem identifies a pre-club, it will subsequently attempt to put the users in said pre-club in contact with each other, as described below. Each pre-club is said to be “determined” by a cluster of messages, pseudonymous users, search profiles, or target objects. To identify pre-clubs, shoppers are clustered by the similarity of their profiles, using for example k-means clustering or soft clustering, and every cluster constitutes a pre-club. If each shopper has an associated search profile set, a better method is available: all search profiles of all pseudonymous users can be clustered based on their similarity, and each cluster of search profiles determines a pre-club whose members are the shoppers from whose search profile sets the search profiles in the cluster are drawn. Each such pre-club is a group of shoppers who are interested in offers with a particular type of profile, and so presumably share an interest. Once the buyers' club subsystem identifies a cluster C of shopper profiles or search profiles that determines a pre-club M, it attempts to arrange for the members of this pre-club to have the chance to participate in a common buyers' club V. In many cases, an existing buyers' club V may suit the needs of the pre-club M. The buyers' club subsystem first attempts to find such an existing club V. In the case where cluster C is a cluster of shopper profiles, V may be chosen to be any existing buyers' club such that the cluster profile of cluster C is within a threshold distance of the mean shopper profile of the active members of buyers' club V; in the case where the cluster C is a cluster of search profiles, V may be chosen to be any existing buyers' club such that the cluster profile of cluster C is within a threshold distance of the cluster profile of the largest cluster resulting from clustering all the search profiles of active members of buyers' club V. The threshold distance used in each case is optionally dependent on the cluster variance or cluster diameter of the profile sets whose means are being compared.

If no existing buyers' club V meets these conditions and is also willing to accept all the users in pre-club M as new members, then the buyers' club subsystem attempts to create a new buyers' club V. Regardless of whether buyers' club V is an existing club or a newly created club, the buyers' club subsystem sends an e mail message to each shopper U in pre-club M who does not already belong to buyers' club V and has not previously turned down a request to join buyers' club V. The e mail message informs shopper U of the existence of buyers' club V, and provides instructions which shopper U may follow in order to join buyers' club V if desired; these instructions vary depending on whether buyers' club V is an existing club or a new club, and depending on the means of communication used by buyers' club V, described below. The e mail message further provides an indication of the common interests of the club, for example by including a list of titles of messages recently sent to the club, or a charter or introductory message provided by the club (if available), or a label generated by methods described above that identifies the content of the cluster of shopper profiles or search profiles that was used to identify the pre-club M.

If the buyers' club subsystem must create a new club V from a pre-club M, several methods are available for enabling the members of the new club to communicate with each other. If the pre-club M is large, for example containing more than 50 users, then the buyers' club subsystem typically establishes a globally accessible bulletin board or World-Wide Web site. If the pre-club M has fewer members, for example 250, the buyers' club subsystem typically establishes an e mail mailing list. In addition to bulletin boards and mailing lists, alternative fora that can be created and in which buyers' clubs can gather include real time typed or spoken conversations (or engagement or distributed multi-user applications including video games) over the computer network and physical meetings, any of which can be scheduled by a partly automated process wherein the buyers' club subsystem requests meeting time preferences from all members of the pre-club M and then notifies these individuals of an appropriate meeting time.

One must be sure that the buyers' club subsystem does not bombard users with notices about communities in which they have no real interest. On a very small network a human could be “in the loop”, scanning proposed buyers' clubs and perhaps even giving them names. But on larger networks the buyers' club subsystem has to run in fully automatic mode, since it is likely to find a large number of buyers' clubs. One may also match together similar shoppers with complementary experiences to share that knowledge—e.g. experience shopping for stereos or computers, or using and servicing the equipment once it has been purchased. Similarly, shoppers looking to buy a given item may be grouped together to form a “shoppers consortium” which can negotiate quantity discounts with vendors. This matching is trivially done by using user profile.

### 1. Incorporating Time in Our Price Point Analysis

Previous sections of this document describe how information about a shopper can be used to characterize her price point and allow us to predict the probability of her accepting offers of various kinds. One very important piece of information that has not been addressed until now is time—clearly, the temporal aspects of our data could have a huge impact on predictive outcomes.

Firstly, using standard econometric techniques, it is possible to analyze purchase data for cycles. For example, standard Fourier analysis can be applied to the amount of money a shopper pays for a certain class of items over time (in essence, we create a time-series for expenditures in a certain category, then decompose it into its component frequencies). This reveals the frequency range at which most purchases of a certain type occur. For example, if a customer normally buys small amounts of milk but buys an extra-large quantity exactly once a month for family gatherings, we could detect this cycle and present the shopper with special milk offers a day or two prior to the monthly purchase—this would remind them of the upcoming milk purchase, as well as increasing the store's chances of seeing the coupon redeemed. Any cycles detected are treated as a time-sensitive adjustment factor to the price point level; by making offers just prior to a customer's habitual purchase date, we reach her when she is especially interested in getting an offer for a certain product. This allows us to increase redemption rates, increase profits on the offers (her increased interest means that we can lower her share of the offer but retain high probability of redemption), and sway product loyalty at a critical juncture (we know she's in the market for product X; we can offer her the rival product Y).

Depending on the nature of the data, approaches other than Fourier analysis may be used. If the time series being analyzed is still fairly information-rich, but exhibits shifts in its underlying frequencies, wavelets or time-distortion methods may prove more useful. If the items are purchased on a cyclical, but infrequent, basis, Fourier-based methods might not have enough information with which to work. In such a case, our system could analyze the data for intervals between purchases. Then, the sample mean of the intervals will reveal the periodicity of the purchases, and the normalized variance of the intervals will reveal how strict the periodicity really is. For example, a customer might have a pet dog who works his way through a bag of dog food roughly once a month. The customer records would show a single purchase of dog food, roughly once a month. The mean interval between purchases, of course, is a month, and we would expect the variance to be fairly small (since the purchases are very regular). Given our confidence in the estimate of the periodicity of dog food purchases for this customer (we might, in fact, pass over other product purchases which exhibit less exact periodicity), we could predict the week in which the customer would find dog food purchases most attractive, and adjust our offers accordingly. An obvious proviso for such an approach is that some customers might only go shopping once a month, causing all standard purchases to have a monthly periodicity—this needs to be taken into consideration, and we might want to only pay attention to cycles that happen at a lower frequency than that of a customer's shopping trips.

By decomposing purchase patterns for various product groups across different frequency ranges, we can learn more about seasonal buying behavior. It may turn out that a certain group of shoppers receives their paychecks exactly once a month. This group would clearly be a target for impulse purchases or slightly more expensive items, as they have more cash to spend at that time.

Time series methods are also useful for detecting trends; one could do a linear regression on sales for a certain product over time, determining the overall direction of a product's sales. This information could be used to adjust offer-generating strategies, as it would indicate a waxing or waning of a customers overall interest in a given product.

### 2. Short-term Versus Long-term Loyalty

Our system is useful for vendors interested in implementing store-wide strategies at different time horizons. For example, one could imagine a vendor interested in purely short-term profits. Such a vendor would use our system to quickly determine a shopper's type (by matching the shopper to the most similar group profile; this group's set of demand curves would then be used to construct a proxy demand curve for the targeted shopper) to create for them offers intended to maximize profits. That is, the size of the offer is balanced against the probability of execution to maximize store profits (this could be determined by maximizing expected profits at various price levels).

A long-term vendor strategy is to cultivate customer loyalty. This might require the sacrifice of short-term profits, but should eventually result in much larger payoffs as customers become loyal and frequent shoppers. By offering the customer significant savings and interesting offers of various sorts, the vendor tries to transform the customer into a regular visitor. One way of doing this is to create generous offers, giving the customer more of the coupon savings than is really necessary for a high probability of redemption. Certain offers might even be good for free items or special gifts. Our system could also be used to analyze temporal buying patterns for efficiency—if a customer buys a single-size product every other day, the system might recommend the economy-size version of that same product. The overall result is that the customer has a rewarding experience at the vendor's store and returns quite frequently.

### 3. Experimental Design for the Delivery of Offers

Once an offer-generating system is in place, it is critical to realize that this system will have an impact on the resulting shopper behavior, and hence on the vectors of purchases and offer redemptions that we use to characterize shoppers. A badly-designed system, rather than producing offers that elicit the most relevant information about a shopper, might only further entrench itself in an erroneous assessment of the shopper's type. For example, one could imagine a shopper who at one point in time redeemed a single offer for steak. A badly-designed system would focus entirely on that event, flooding the shopper with offers for meat products. If the shopper accepts any of these offers (which all happen to be for meat products), the badly-designed system will become even more convinced that the shopper is interested only in meat. Eventually, one could imagine the shopper growing bored with the offers given to her by the generation system, weakening her overall store loyalty.

Thus, while it is important for an offer-generating system to create offers that are most likely to be redeemed (based on past behavior), our system reserves a certain percentage (e.g. 20%) of offers for experimental purposes. The purpose of these experimental offers is to elicit whatever information is most relevant at the time for determining the true nature of the shopper. Crudely put, our experimental offers, while not extreme in their redemptive values, will fill in the largest existing gaps of the demand curves that we are in the process of creating for each shopper. On a more sophisticated level, one can think of these experimental offers (if redeemed) as eliciting the particular information about a shopper that is most relevant for understanding the shopper's type. For example, one could imagine a hardware store containing tools useful either for left-handed or for right-handed shoppers. A particular shopper, who so far has only bought nails, cannot yet be categorized as either a left- or right-handed shopper, a fact which makes it very hard to predict the appeal of a given offer to him. Instead of flooding him with offers for nails, it would be more useful to give him very generous coupons (to maximize the probability of redemption) for a left-handed shear and a right-handed shear. If he purchases either of these items, we'll be able to place him on one or the other sides of a major category (handedness) that is central to understanding and predicting the behavior of shoppers in this hardware store.

Our system implements a hierarchical decision tree (similar to those used for the automatic generation of classification rules) to choose which offers are most relevant to understanding the shopper's type (i.e., most representative group) and demand curve characteristics. Another useful approach would be to cluster the shoppers into characteristic groups, based on the similarity of their shopping history profiles. Given a new shopper, we would generate offers that, if redeemed, would allow us to place her in a set of clusters, and eventually, a single cluster. Thus, offers not suitable for distinguishing a customer's characteristic cluster (or type) would be avoided—for example, if every shopper in a grocery store purchases milk, the redemption of a milk coupon wouldn't be indicative of any particular cluster. In a sense, we want to distribute offers that lie along the principal component axis of the clusters; redemption of such offers would most quickly identify a customer's type.

Given that such an offer has been redeemed, we should be able to associate the customer with a minimal number of clusters. The demand curves of members of these clusters could be aggregated to create, at least temporarily, a proxy demand curve suitable for predicting the behavior and reactions to offers of our new customer. Over time, we should observe more and more offer redemptions by the new customer; at first, these will be used to fine-tune our knowledge of the customer's type. Eventually, we'll have enough information that we can give up the proxy demand curve and start using a demand curve that is uniquely based on the shopper's observed behavior. At this point, the experimental offers will be crafted not to place the shopper in a characteristic cluster, but to fill out our detailed knowledge of her personal price points. It is at this time that our system will probe the shopper's response to offers for categories of items never purchased. If a customer has never bought hair-care products, why not? A slew of extremely generous (perhaps even free) offers for hair-care products would be quite useful for understanding whether or not a shopper has any interest in such items. A long string of non-redemptions would indicate that this customer truly has no interest in such products. If patterns of lack of interest emerge among groups of customers, a human sales representative could contact them personally and determine the reasons for this. It may be that the hair-care department has slipped, and that drastic changes are needed to make it competitive with rival hair-care departments.

### 4. Use of Models for Inventory Control

It should be noted that once individual price points have been determined, we have the ability to model the demand function of all shoppers involved with a given retailer. As previously mentioned, infrequent shoppers will require a proxy (that is, they will be represented by the model of the group they most seem to fit), whereas frequent shoppers have contributed enough data points to allow us to model and understand their behavior on an individual basis.

Given that we know which shoppers frequent a particular retail outlet, given that we have models for their demand functions and overall shopping behaviors, and given that we know what merchandise will be available at what price, it is possible to aggregate our predictions for individual shoppers' purchases to the level of the store. That is, we can conditionally predict the quantity and type of merchandise that a given store will sell over a certain period of time.

Operationally, this is simple enough. We can treat shopper I as a vector of expected purchases; i.e., vi=[ E(q₁ᵢ),E(q₂ᵢ), . . . , E(qₙᵢ) ]. Note here that E (qⱼᵢ) represents the expectation of the number of items j sold to customer I (conditional on the current time period, offers available, past information on the shopper, etc.) . The expected sales for the entire store would then be vstore=Σivi.

The ability to make such a prediction allows us to finely tune the schedule controlling supply delivery and inventory size, creating a “just-in-time” delivery system (already well-known and detailed in the operations research literature). The innovation here is not the system itself, but the quality and nature of the sales predictions that are fed into it. Knowing the number of items of a certain type that are expected to be moved in a week, for example, allows us to greatly reduce the storage space needed for inventory: items that aren't expected to sell well are ordered in much smaller quantities, and don't clog up back˜room storage areas. Or, if storage space is plentiful but deliveries expensive, we could predict needs several weeks ahead and order all the goods to be brought in a single monthly delivery.

A statistical understanding of our models will allow us to make predictions within certain bands of confidence; this will allow a retailer to schedule slightly more conservative amounts of merchandise, using risk metrics methods to minimize the probability of actually running out of a certain good.

Given our detailed understanding of shoppers' behaviors and their responses to offers for various items at various prices, we could easily extend our knowledge to new retail outlets (or currently established retail outlets selling a new type of merchandise). In effect, we would generalize our knowledge to the new location or for the new product. Suppose a new type of merchandise, long on sale at Store B (perhaps a test market), is introduced to Store A. We could map each customer (using metrics previously described) in Store A to the most similar customer(s) in Store B; we would then use those customers' demand curves to create a proxy demand curve for the Store A customer. After having done this for every customer in Store A, we can now predict sales volume for that product at Store A. We could take into account the extra time it will take for the new product to “catch on” in Store A by widening the confidence intervals on our prediction.

### Semi-automatic Selection of Targeted Offers and Other Information

Because there are obviously many external and customer specific factors which can affect ultimate buying activity and customer loyalty (and many of these are tricky to identify and accurately assess, there may be certain circumstances in which the vendor may wish to have greater control over the system's (otherwise autonomous) targeting decisions. Within the domain of the present retail application (in addition to perhaps numerous other exemplary commercial domains ranging from general advertising to news, insurance, financial services or stock portfolio management), the present recommendation system could instead be usefully implemented either as (or in conjunction with) a rules generation system. In these examples the proposed technique may be very useful in certain applications in which some fixed (manually crafted) rules are applied but where perhaps numerous other less apparent rules can only be gleaned from statistics within a very large data set of transactions (or click stream data). In some cases (e.g. in the presently disclosed system for recommending offers or targeted discounts to certain groups of shoppers) it is desirable for the system to recommend if appropriate, that certain pre- existing hand crafted rules should be modified in order to improve accuracy or targeting efficiency, e.g. recommending to certain type profiles of users (or those having requested certain items) personalized ads, offers, discounts, joint promotions or topically relevant ancillary materials about the product (indexed from the vendor database or the WWW), but not other immutable rules for example, a user request for a product description, an electronic purchase order address form (or liability disclaimer) if the user submits a “buy” request for that item. Using a text generation UI, the rule recommendations are expressed to the vendor, she is then empowered with the ability to approve, deny, modify or allow autonomous implementation of the rule recommendations. Complex rules (which are often difficult for humans to understand) can be paired down using certain methods such as principle components factor analysis without sacrificing significant predictive accuracy on the part of the system.

### SUMMARY

A method has been described for the customized determination of which products a purchaser would be most likely to buy, and which offering price and promotions (coupons, advertisements) can be expected to maximize the vendors profitability. In particular, the system automatically constructs profiles of the shoppers based on their demographics, and history of information request and purchases. The shoppers' behaviors in response to product advertisements or other promotions are then predicted by finding what the other shoppers with the most similar profiles have done. “Rapid profiling” techniques can be used to characterize the shopper with a minimum number of initial questions; shopper profiles are then automatically updated as their on-line shopping is monitored. Additionally, we present similar profile-based methods for custom construction of products such as insurance or investment portfolios, for custom electronic shopping mall layout, and for automatic construction of buyers' clubs for commerce. These buyers' clubs may either be groups of shoppers and vendors wishing to trade with one another, or groups of shoppers wishing to share expertise. These methods of suggesting products, prices, and promotions can also be used in conjunction with smartcards and with electronic cash. Finally, the profiles developed on-line can be used to devise off-line sales and marketing strategies.

What is claimed:

1. A system for the presentation of user offers in the form of customized promotions to consumers who access said system via one of a plurality of user terminals that are served by said system, comprising:
means for automatically generating user profiles for said consumers, each of said user profiles being generated from an identification of said consumer and a record of past purchases made by said consumer; and
means for automatically generating at least one user offer for an identified consumer at a one of said plurality of user terminals, each of said at least one offer being generated from data contained in a one of said user profiles generated for said customer.

2. The system of claim 1 further comprising:
means for transmitting said at least one user offer to said consumer at said user terminal in the form of a coupon.

3. The system of claim 1 wherein said user terminal is a point of sale terminal, said system further comprising:
means for transmitting said at least one user offer to said consumer at said user terminal in the form of automatic price adjustment on purchases made by said consumer at said point of sale terminal.

4. The system of claim 1 wherein said means for automatically generating at least one user offer comprises:
means for correlating a user profile, generated for an identified customer, with products offered for sale by a vendor served by said system to identify ones of said products that are likely to be of interest to said identified user.

5. The system of claim 4 wherein said means for automatically generating at least one user offer further comprises:
means for generating, in response to receipt of said data from said one user terminal indicative of a purchase of a product by said customer, a user offer for a product, determined as a function of said purchase of a product by said customer; and
means for transmitting said user offer to said user terminal for display thereon to said identified customer.

6. The system of claim 1 further comprising:
means for identifying said customer in response to said identified user activating a selected one of said user terminals.

7. The system of claim 6 wherein said means for identifying comprises:
means for reading data from a customer provided data medium, in response to said identified customer activating a one of said user terminals, to securely identify said customer.

8. A method for the presentation of user offers in the form of customized promotions to consumers who access said system via one of a plurality of user terminals that are served by said system, comprising the steps of:
automatically generating user profiles for said consumers, each of said user profiles being generated from an identification of said consumer and a record of past purchases made by said consumer; and
automatically generating at least one user offer for an identified consumer at a one of said plurality of user terminals, each of said at least one offer being generated from data contained in a one of said user profiles generated for said customer.

9. The method of claim 8 further comprising the step of:
transmitting said at least one user offer to said consumer at said user terminal in the form of a coupon.

10. The method of claim 8 wherein said user terminal is a point of sale terminal, said method further comprising the step of:
transmitting said at least one user offer to said consumer at said user terminal in the form of automatic price adjustment on purchases made by said consumer at said point of sale terminal.

11. The method of claim 8 wherein said step of automatically generating at least one user offer comprises:
correlating a user profile, generated for an identified customer, with products offered for sale by a vendor served by said system to identify ones of said products that are likely to be of interest to said identified user.

12. The method of claim 11 wherein said step of automatically generating at least one user offer further comprises:
generating, in response to receipt of said data from said one user terminal indicative of a purchase of a product by said customer, a user offer for a product, determined as a function of said purchase of a product by said customer; and
transmitting said user offer to said user terminal for display thereon to said identified customer.

13. The method of claim 8 further comprising the step of:
identifying said customer in response to said identified user activating a selected one of said user terminals.

14. The method of claim 13 wherein said step of identifying comprises:
reading data from a customer provided data medium, in response to said identified customer activating a one of said user terminals, to securely identify said customer.
